(19) United States
(12) Patent Application Publication
(10) Pub. No.: US 2025/0361022 A1
(43) Pub. Date: Nov. 27, 2025

(54) SUBORBITAL NODES FOR AERIAL MESH COMMUNICATIONS SYSTEMS

(71) Applicant: Star Mesh LLC, Princeton Junction, NJ (US)

(72) Inventor: Gerald R. Schloemer, McHenry, IL (US)

(73) Assignee: Star Mesh LLC, Princeton Junction, NJ (US)

(21) Appl. No.: 18/864,914

(22) PCT Filed: May 19, 2023
(86) PCT No.: PCT/US2023/022818

§ 371 Date: Nov. 12, 2024

Related U.S. Application Data
(60) Provisional application No. 63/345,051, filed on May 24, 2022.

(51) Int. Cl. B64D 43/00; B64B 1/58; B64C 27/00; H01Q 21/20; H04B 7/185

(52) U.S. Cl. CPC B64D 43/00; B64B 1/58; B64C 27/00; H01Q 21/20; H04B 7/18504

(57) ABSTRACT

A radio communication system includes non-orbiting aerial nodes providing a radio route between terrestrial nodes. The non-orbiting nodes have a plurality of directional antennas pointing horizontally in multiple directions for sending radio signals to and receiving radio signals from other non-orbiting aerial nodes in a first frequency band, and a plurality of directional antennas pointing toward the surface of the earth for sending radio signals to and receiving radio signals from multiple terrestrial nodes in a second, different frequency band. The aerial nodes include route creation circuitry for creating a radio route between terrestrial nodes via one or more aerial nodes and data transmission circuitry for transmitting data over the route. The non-orbiting nodes can be one-piece lighter-than-air drones, two-piece lighter-than-air drones having suspended communication capsules, heavier-than-air rotary-wing drones with or without lift assist from a lighter-than-air gas, having suspended communication capsules, or balloons with suspended communication capsules.

### CROSS-REFERENCE TO RELATED APPLICATION

This application claims benefit of U.S. provisional application No. 63/334,051 filed May 24, 2022.

### BACKGROUND

The assignee's issued patents and patent publications disclose a wide variety of space-based systems, methods and apparatus for transmitting data via non-terrestrial (aerial) nodes, including orbiting nodes (satellites) and non-orbiting nodes (drones and/or balloons). They use novel route creation and data transmission protocols for establishing node-to-node radio routes between terrestrial nodes, between non-terrestrial nodes, and between non-terrestrial and terrestrial nodes. The assignee's protocols support simultaneous transmission of data from large numbers of originating nodes to respective destination nodes over long distance routes that can include multiple orbiting satellites and/or other types of aerial nodes. Those patents and patent publications include U.S. Pat. Nos. 10,084,536, 10,085,200, 10,291,316, 10,447,381 and 10,979,136, and Pubs. No. US 2021/0359751, No. US 2022/0029699, No. US 2022/0173795 and No. US 2022/0173796.

In a typical implementation routes are created step by step via signals sent from terrestrial nodes and received by one or more aerial nodes (drones, balloons or satellites), which in turn send signals that are received by other aerial nodes or terrestrial nodes. For example, a first aerial node receiving a signal from a sending terrestrial node sends routing signals that may be received either by other aerial nodes or other terrestrial nodes. A terrestrial node or another aerial node receiving a routing signal can then transmit data back to the original sending terrestrial node via the aerial node from which it received the routing signal. A route back to a sending terrestrial node can comprise one or more aerial nodes. More advanced versions of this “reverse routing” technology are disclosed in U.S. Pat. No. 10,979,136 (“the '136 patent”) and Pub. No. US 2022/0173796 (“the '796 publication”). The assignee's protocols can use statistical probabilities to create routes and transmit data via satellites without heavy, expensive thrusters and fuel to maintain them in prescribed positions. Instead, they use light, inexpensive satellites whose locations need not be controlled and can be either deployed in or allowed to assume a stochastic distribution.

The present disclosure relates to various constructions of lighter-than-air and heavier-than-air, lift-assisted non-orbiting nodes (drones and balloons) particularly useful in systems with or without satellites. That is, the disclosed constructions can be used in communications systems that use any type of non-orbiting aerial vehicle as a system node in a radio route. The disclosed drones are capable of use in local systems involving drones only or in wider area systems in combination with satellites, as described below with reference to FIGS. 12 to 14. In civil applications the drones will typically be deployed at altitudes of at least 10 miles to avoid interfering with commercial aviation. Although lighter-than-air vehicles will inherently be capable of occupying higher altitudes, in preferred embodiments they will be deployed closer to the lower 10-mile limit to increase drone-to-ground signal strength. It will also be appreciated that some applications will use drones below the lower 400-foot ceiling allowed by FAA regulations in otherwise non-restricted airspace (such as near an airport). These drones could find use in urban areas or mountainous terrain where nodes on the ground might not see any (or only a limited number of) higher altitude drones or satellites. They can also provide more reliable communication with terrestrial nodes in buildings or other locations where the strength of radio links with higher altitude drones might be compromised.

The non-orbiting nodes of the present disclosure will also be useful in certain applications in which the 400-foot ceiling limitation has been suspended by emergency government intervention, such as during or after situations in which communications over a particular area are compromised or disrupted due to severe weather, an earthquake, or other natural disaster. Airlines could be directed to suspend operations in the disaster zone to clear the region in favor of non-orbiting, low-altitude nodes. In the absence of a low-ceiling limitation on node in such situations, the drones described in this disclosure can provide ready communications with personnel on the ground, making them ideal for maintaining contact between command posts and individual emergency workers and law enforcement personnel. Drones at 1,000-2,000 ft. will be capable of transmitting and receiving signals from the ground of sufficient strength to ensure the integrity of data transmissions using the drones. Even though drones at such altitudes may be vulnerable to severe weather or other hazards, the drones themselves are inexpensive, easy to replace, and automatically begin participating in route creation and data transmission as soon as they are deployed.

### BRIEF DESCRIPTION OF THE DRAWINGS

The manner by which such drones and communications systems achieve certain objects of the claimed subject matter will be better understood from the detailed description of preferred embodiments below, when taken in conjunction with the accompanying drawings, in which like numerals and letters refer to like features throughout. The following is a brief identification of the drawing figures used in the accompanying detailed description.

FIG. 1 is a schematic side view of a first preferred embodiment of a non-orbiting aerial node comprising a unitary lighter-than-air rigid airship (“LTA”) drone for use as a type A node in the system described with reference to FIGS. 12 to 14.

FIG. 2 is a top view of the LTA drone depicted in FIG. 1.

FIG. 3 is a notional cross-section of the LTA drone depicted in FIGS. 1 and 2 showing the placement of certain internal components of a type A drone in the system described with reference to FIGS. 12 to 14.

FIG. 4 is a schematic representation of various internal operational and structural components of the LTA drone depicted in FIGS. 1 to 3.

FIG. 5 is a notional cross-section of the LTA drone depicted in FIGS. 1 to 3 illustrating a technique of stabilizing the pitch of the LTA drone.

FIG. 6 is a view of the LTA drone taken as shown in FIG. 5.

FIG. 7 depicts an electromagnetic array for controlling the heading of the LTA drone in the preceding drawings.

FIG. 8 is a schematic side view of a second preferred embodiment of a lighter-than-air drone for use as a type A node in the system described with reference to FIGS. 12 to 14, in which certain operational components of the first preferred embodiment depicted in FIGS. 1 to 7 are housed in a communications capsule suspended from a lighter-than-air rigid airship.

FIG. 9 is a top view of the communications capsule taken as shown in FIG. 8.

FIG. 10 is a front view of the communications capsule taken as shown in FIG. 8.

FIG. 11 is schematic side view of a third preferred embodiment of a heavier-than-air drone for use as a type A node in the system described with reference to FIGS. 12 to 14, in which the communications capsule in FIGS. 8 to 10 is suspended from a rotary-wing aircraft with lift assist provided by a lighter-than-air gas.

FIG. 12 is a Mercator projection of the earth showing the orbital paths of a constellation of stochastically distributed satellites deployed at various altitudes with different inclinations relative to the equator for use in the four-level communications system shown in FIG. 14.

FIG. 13 is a schematic diagram illustrating a local area routing network comprising radio links created to transmit data to a terrestrial node in a system comprising plural non-orbiting aerial nodes such as those depicted in FIGS. 1 to 11.

FIG. 14 depicts exemplary radio routes in a four-level communications system including non-orbiting aerial nodes such as those shown in FIGS. 1 to 11 and orbiting nodes in a constellation of satellites such as that shown in FIG. 12.

One skilled in the art will readily understand that the drawings are not strictly to scale, but nevertheless will find them sufficient, when taken with the detailed descriptions of preferred embodiments that follow, to make and use the present invention.

### DETAILED DESCRIPTION OF PREFERRED EMBODIMENTS

The detailed description that follows is intended to provide specific examples of particular embodiments illustrating various ways of implementing the claimed subject matter. It is written to take into account the level of knowledge of one of ordinary skill in the art to which the claimed subject matter pertains. Accordingly, certain details may be omitted as being unnecessary for enabling such a person to realize the embodiments described.

The following detailed description of certain preferred embodiments of the subject matter is organized as follows:
I. Definitions
II. Non-Orbiting Aerial Node (Drone) Embodiments
   A. Unitary Lighter-Than-Air Drone
   B. Two Part Lighter-Than-Air Drone
   C. Two Part Heavier-Than-Air Rotary-Wing Drone with Lift Assist
III. Route Creation in Systems with Orbiting/Non-Orbiting Aerial Nodes
   A. General Description of Exemplary Satellite Deployments
   B. Local and Wide Area Routing Systems and Methods
      1. Local Area Data Transmission Using Drones
      2. Wide Area Data Transmission Using Drones and Satellites
      3. Examples of Local Area and Wide Area Routes
IV. Operational Applications of Disclosed Non-Orbiting Aerial Nodes
V. Summary and Conclusion

### I. Definitions

The detailed description in the next sections uses numerous terms intended to have specific meanings. For satellite deployments, specific terms relate to options for systems and methods disclosed below using just satellites alone or in combination with non-orbiting aerial nodes such as the LTA and lift-assisted drones depicted in the drawings. Satellites can be deployed in known, fixed orbits or, in certain advantageous embodiments in which route creation is based on the statistical likelihood of creating node to node links, with satellites that are “stochastically distributed” or in “unconstrained orbits.” These terms are both related to the term “random orbits” used in the assignee's patents and patent publications referenced earlier. The intended meaning of these terms is that a satellite, once deployed in orbit, is permitted to assume any orbital path without the application to the satellite of motive power by an onboard propulsion system. However, neither term is intended to exclude initial deployment of a satellite at a particular orbital inclination, altitude, or attitude, or at a particular geolocation relative to another satellite in the system. Stated another way, “stochastically distributed,” “unconstrained” or “random” orbits means that satellites are deployed so that their locations relative to other satellites and to the earth at any given time are not controlled after they are inserted into orbit, although they may be initially deployed in a manner designed to provide coverage of a particular swath of the earth's surface. The satellites need not be deployed randomly in a mathematical sense, but it is within the scope of these terms to use mathematical methods to determine satellite deployment direction, inclination, altitude, velocity, etc. that take into account the geographic areas of the earth to be served by radio routes using one or more satellites. In addition, individual satellites can be launched in different orbital directions (eastward or westward around the earth) in combination with any of the aforementioned or other deployment techniques. For example, the satellites could be ejected in different directions at different velocities from a launch vehicle traveling in an orbital direction (that is, generally eastward or westward), so that after a time they will have separated themselves into “random” orbits in an essentially unconstrained manner. This will make a constellation of multiple satellites appear to an observer on earth to be stochastically distributed in random orbits.

The term “passive attitude control” and the related term “without active attitude control” as applied to a satellite in the systems described herein mean that the satellite carries no attitude control mechanism with parts that are moved to different positions by onboard apparatus requiring motive power to intentionally change the attitude of the satellite with respect to an external frame of reference. Examples of active attitude control mechanisms would be propulsion systems with thrusters capable of imparting moments on the satellite to cause it to rotate, or mechanical actuators with moving parts used to change the center of gravity or angular momentum of the satellite or the position and/or orientation of a satellite's solar panels. The terms do not exclude the use of passive means for changing or controlling satellite attitude without using moving parts, whereby a satellite may tend to assume a particular attitude over time simply by virtue of its structure and the materials used in its manufacture. In addition, the terms do not exclude using various approaches such as using electrical means to stabilize the attitude of the satellites within certain limits. This could include techniques such as selective switching of arrays of one or more electromagnets to vary their interaction with the earth's magnetic field in a manner that influences satellite attitude. Similar techniques known presently or developed in the future are also covered by the terms “passive attitude control” and “without active attitude control.”

A “node” or “system node” is a physical object with one or more transceivers for transmitting radio signals intended to be received by other nodes and for receiving radio signals transmitted from other nodes. Nodes can be terrestrial ground stations, examples of which are described in the next paragraph, or transceivers above the earth's surface (“aerial nodes”). Aerial nodes include, but are not limited to, satellites orbiting the earth and non-orbiting drones, which can be heavier-than-air fixed-wing or rotary-wing aircraft, and lighter-than-air rigid airships with or without propulsion and steering systems. Non-orbiting aerial nodes also include balloons. In this context “rigid” means an enclosure or casing with a substantially fixed shape and only capable of limited deformation. Similar to satellites, non-orbiting aerial nodes need not be maintained in precise, predetermined positions to support route creation. However, since they are subject to atmospheric conditions they may include propulsion and guidance systems sufficient to limit their range of motion. This disclosure is principally concerned with routes between aerial nodes of the same type at the same altitude or between aerial nodes of the same or different types at multiple altitudes.

A “ground node” or “terrestrial node” can refer to a ground station at a fixed location, such as a terrestrial cellular telephone switch, or to a mobile node that can move from place to place under motive power while transmitting and receiving radio signals. The term “mobile ground node” or “mobile terrestrial node” can also refer to an aircraft in flight serving as an originating node from which a passenger desires to transmit data to a destination ground node comprising another aircraft in flight or to a destination ground node actually on the earth's surface; or it can be a destination ground node on the earth's surface from which a system user desires to transmit data to an aircraft in flight or to another system ground node on the earth's surface. Elevated ground nodes will enable more users to connect to a communications system in areas of low population density. The term “mobile ground node” or “mobile terrestrial node” can further mean a moving surface vehicle (such as an automobile) from which an occupant desires to transmit data to a destination ground node comprising an aircraft in flight or to a destination node actually on the earth's surface; or it can be an originating node on the earth's surface from which a system user desires to transmit data to an aircraft in flight or to another system node on the earth's surface. Examples of other types of mobile ground nodes are, without limitation, portable devices such as smartphones and tablet computers, trucks and buses, and ships at sea such as cruise ships, fishing boats (of all sizes) and pleasure boats. Accordingly, it will be understood that terms such as “mobile ground node” and “mobile terrestrial node” used in this disclosure are meant to be interpreted broadly as including any node that forms the terminus of a route from which data is transmitted (an “originating node”) or at which it is received (a “destination node”), whether or not it is physically on the earth's surface, in the air above the surface, or on a body of water.

“Routing messages” and “data communications” (or “data transmissions”) are also used in the description that follows. A “routing message” is a radio signal sent from a system node (terrestrial or aerial) that contains information or has a property that can be used for determining the suitability of the node for inclusion in a multi-link radio route. A “data communication” comprises content (digital or otherwise) sent over a radio link between two orbiting satellites or between two non-orbiting aerial nodes or between a satellite or other non-orbiting aerial node and a terrestrial node, unless otherwise indicated explicitly or by context. While not limited as such, the systems and methods described herein are particularly well suited for the transmission of data in packets, defined here in the generally accepted sense as a collection of digital data with a portion representing the content of the transmission (sometimes referred to as the “payload”), and a control portion (sometimes referred to as a “header” or “trailer”), which contains information enabling the payload to be delivered successfully, such as source and destination addresses, error detection codes, sequencing information, and encryption information. A given radio signal can include both a routing message and a data communication. Throughout the description herein, the term “radio” is not limited to references to electromagnetic radiation in frequencies commonly referred to as radio waves. It is meant to encompass electromagnetic radiation of any frequency capable of transmitting information, including light, microwaves, VHF (“very high frequency”), UHF (“ultrahigh frequency”), etc.

As those skilled in the art will recognize that, in the description herein, control circuitry and components described and depicted in the various figures are meant to be exemplary of any electronic computer system capable of performing the functions ascribed to them. Such a computer system will typically include the necessary input/output interface devices and a central processing unit (CPU) with a suitable operating system, application software for executing program instructions, and transient and non-transient memory modules. In addition, terms referring to elements of the system are used herein for simplicity of reference. For example, the terms “component,” “module,” “system,” “apparatus,” “interface,” or the like are generally intended to refer to a computer-related entity, either hardware, a combination of hardware and software (firmware), software, or software in execution, unless the context clearly indicates otherwise. In addition, the term “module” or “component” does not of itself imply a self-contained structure, but rather can include various hardware and firmware that combine to perform a particular function. In that regard, a component or module may be, but is not limited to being, a process running on a processor, a processor, an object, an executable, a thread of execution, a program, and/or a computer. By way of illustration, both an application running on an electronic computing device and the device itself can be a component. One or more components may reside within a process and/or thread of execution and a component may be localized on one computer and/or distributed between two or more computers.

### II. Non-Orbiting Aerial Node (Drone) Embodiments

As already stated, communications systems employing the assignee's methods and protocols can be used with a variety of types of non-orbiting aerial nodes. Various constructions of heavier-than-air drones have been proposed, such as the Sunglider™ high-altitude platform-station (HAPS) developed by AeroVironment, Inc., described at www.avinc.com/about/haps. These so-called “pseudosatellites” are fixed-wing aircraft with a wingspan of 255 ft. (compare with a Boeing 747 wingspan of 211 ft.) carrying solar panels and 10 propellers. They will be expensive to build and launch, especially in numbers sufficient to support a large volume of communications. Their size will make them especially vulnerable if they are used in a hostile environment like a combat zone where they are being used to support direct communications with combat troops in place of destroyed local infrastructure. There will be a significant cost penalty to replace large numbers of Sunglider™ drones in a setting where they will have a high “mortality” rate.

The drones described here avoid these shortcomings. They are inexpensive to build and launch. They can be deployed at low altitudes in swarms that make it more likely that they can establish communications with the ground. This can be critical in situations where local infrastructure has been destroyed or compromised, such as in a war zone or natural disaster. They support the assignee's unique routing protocols that do not require the drones to be in fixed positions and enable them to self integrate into the communication system almost immediately after deployment.

### A. Unitary Lighter-Than-Air Drone

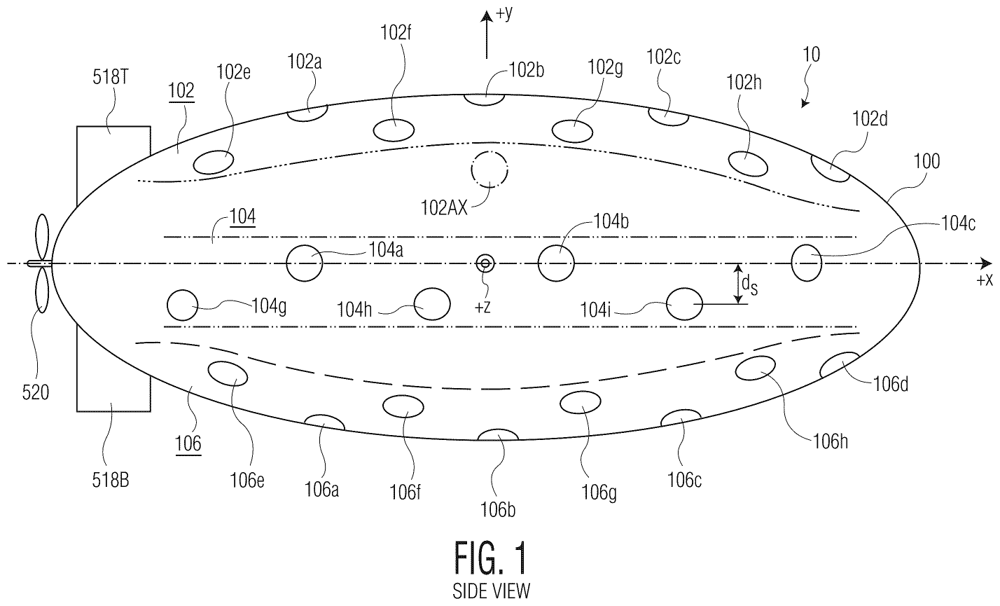

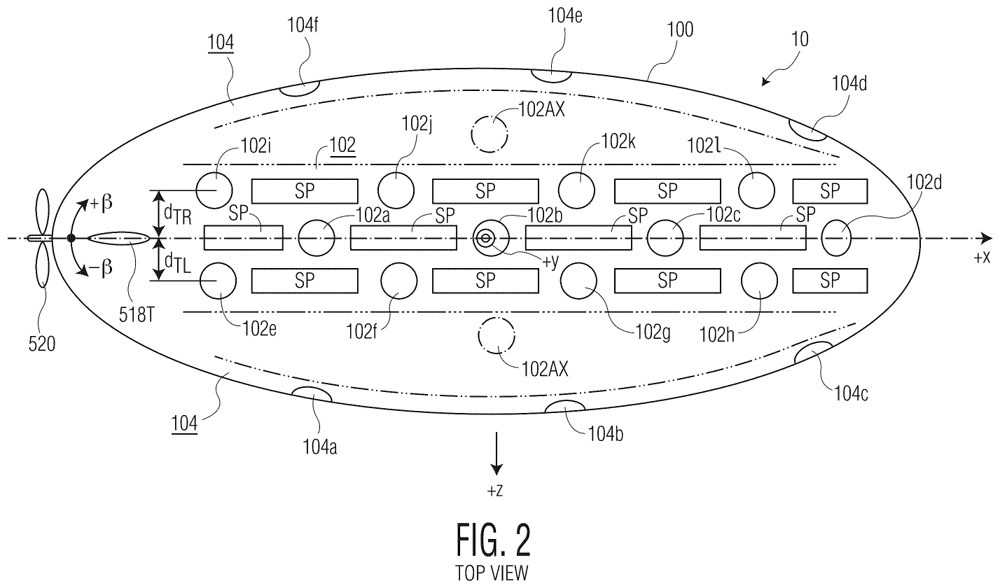

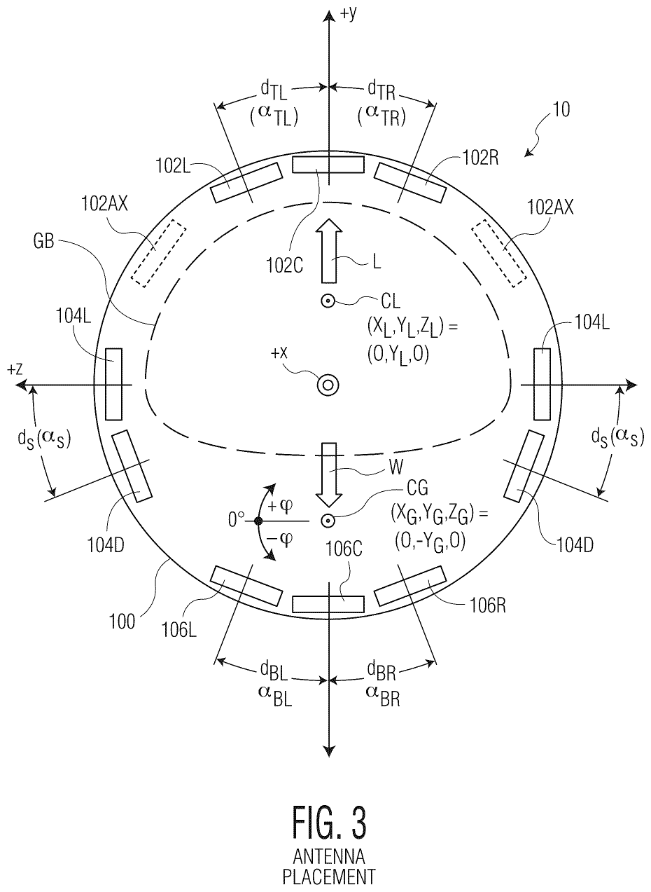

FIGS. 1 to 3 depict one preferred LTA drone embodiment comprising a rigid airship designed to operate as a Type A node in systems such as those described further below and in the '796 publication. For purposes of this description, a right-hand coordinate system is superimposed on the drone 10, with the positive x-axis (+x) along the centerline of the drone generally defining a forward heading, the positive y-axis (+y) pointing vertically upward in the nominal orientation of the drone, and the positive z-axis (+z) pointing to the left as viewed in the −x direction. In this instance the drone 10 comprises a regular ellipsoidal casing 100 symmetrical about all three axes, with a substantially circular cross-section in the y-z plane centered on the x-axis (FIG. 3) and an elliptical cross-section in the x-y and x-z planes (FIGS. 1 and 2) —geometrically, a prolate spheroid. (In this and similar contexts, “substantially circular” means that the shape can deviate from an exact circle if it still enables the drone to perform its intended functions.) In the description that follows, the coordinate system is attached to the drone, unless the context indicates otherwise, and drone “orientation” refers to the relation of the x-, y- and z-axes relative to the surface of the earth. (The drawings depict the coordinate system origin at the centroid of the ellipsoid casing 100 of the drone 10, solely for ease of illustration and description.) FIGS. 1 to 3 depict the drone in its nominal orientation during deployment in a communications system like that described below with reference to FIGS. 12 to 14 and FIG. 12 of the '796 publication, with the drone +y axis pointing upward normal to the earth's surface, the x-y plane parallel to the earth's surface, with a heading in the +x direction. The “top,” “side” and “bottom” surfaces are denominated as such in that context; “right” and “left” are taken as viewed in the −x direction.

The LTA drone 10 includes three arrays of separately operable directional antennas. In the present embodiment, a top antenna array 102 comprises a plurality of antennas distributed in a region between the dash-three-dot lines in FIGS. 1 and 2; a side antenna array 104 comprises a plurality of antennas distributed in a region between the dash-two-dot lines in FIGS. 1 and 2 (which extends to the right-hand side of the drone in like fashion); and a bottom antenna array 106 comprises a plurality of antennas distributed in a region marked in FIG. 1 by a dashed line (which also extends to the right-hand side of the drone in identical fashion as shown in FIG. 3). In one preferred embodiment the antennas have parabolic reflectors with circular mouths and a central feed, and are mounted to the drone with their mouths proximate to the inside surface of the drone 10. In another embodiment the parabolic antennas can have multiple feeds to increase the number of beams produced by each, as described in the assignee's U.S. Pat. No. 10,085,200, thereby improving chances of pairing antennas between different drones. The antennas are depicted as circles in FIGS. 1 and 2, but depending on the manner in which they are mounted in place, they may or may not actually be visible from the exterior of the drone.

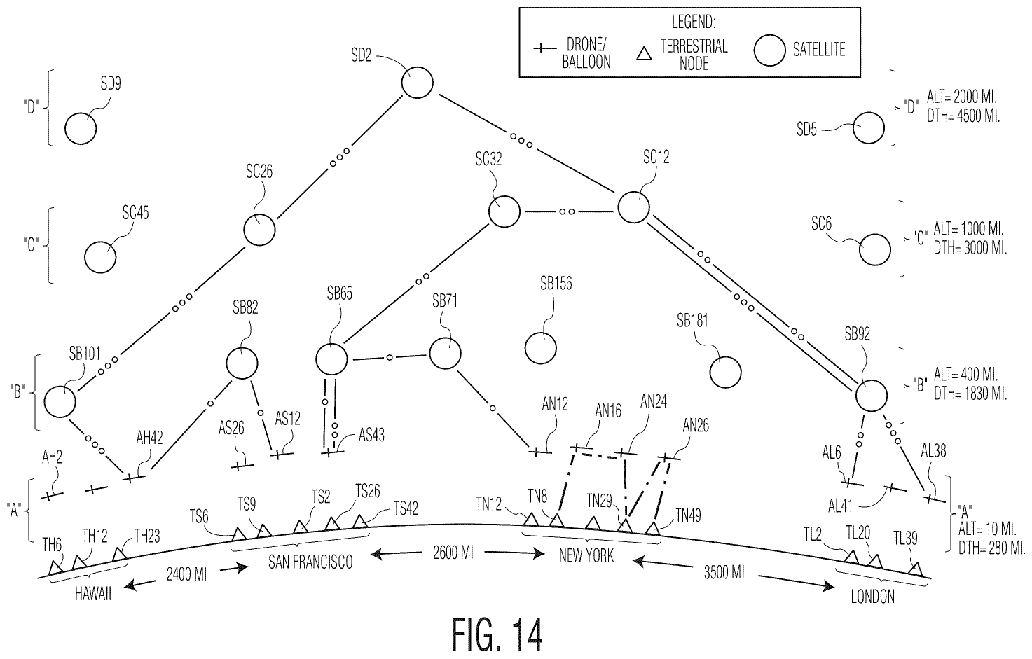

The top antenna array 102 is designed to make radio links with satellites in Layers B, C, and D in the system depicted in FIG. 14. In the present embodiment it includes a total of 12 antennas: four central antennas 102a, 102b, 102c and 102d are equally spaced with the centers of their mouths on a line where the x-y plane intersects the surface of the drone; four more top antennas comprising sideways-left-offset antennas 102e, 102f, 102g and 102h are equally spaced with their mouths centered on a line displaced a predetermined distance to the left of the line of central antennas; and four antennas comprising sideways-right-offset antennas 102i, 102j, 102k and 102l are equally spaced with their mouths centered on a line displaced a predetermined distance to the right of the line of the central antennas. The center-to-center distance between the antennas in each row of sideways-offset antennas is the same as the central antennas, with each sideways-offset antenna being located one-half the distance between adjacent central antennas.

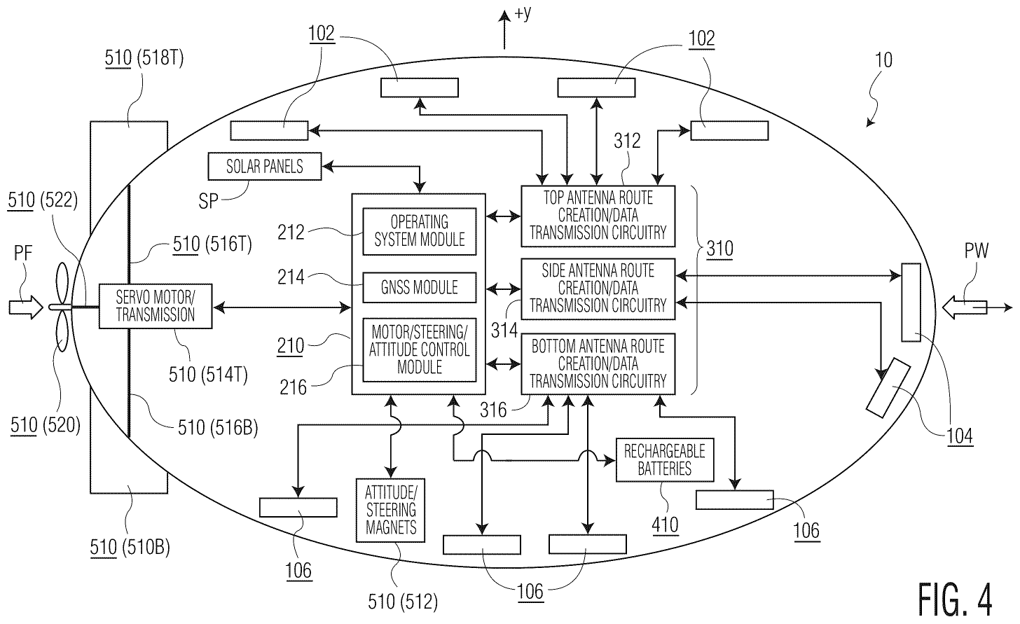

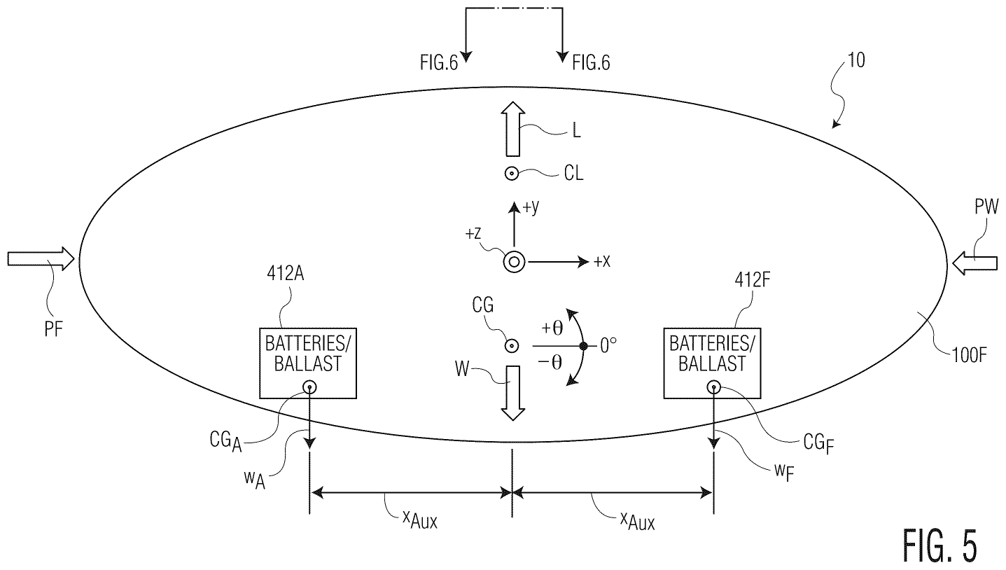

The circumferential placement of the top-array antennas in the y-z plane is shown notionally in FIG. 3, which represents the central antennas 102a, 102b, 102c and 102d as a single notional antenna 102C, the left-offset antennas 102e, 102f, 102g and 102h as a single notional antenna 102L, and the right-offset antennas 102i, 102j, 102k and 102l as a single notional antenna 102R. In the present embodiment the centers of the left-offset antennas 102L are spaced a circumferential distance d_{TL} from the centers of the line of central antennas 102C, and the right-offset antennas 102R are spaced a circumferential distance d_{TR} from the line of central antennas 102C. The LTA drone 10 will have onboard rechargeable batteries (see FIGS. 4 and 5, discussed below), and a plurality of solar cell arrays SP for converting light from the sun to electric current for charging the batteries. In the present embodiment, the solar cell arrays are disposed in spaces between the antennas in the top antenna array, as shown in FIG. 2.

Referring to FIG. 3, the angle α_{TL} between the y-axis and the center of the antenna(s) 102L will increase along the x-axis (in both directions from the origin at x=0) as the diameter of the drone decreases; the same is true of the angle α_{TR} between the y-axis and the center of the antenna(s) 102R. For example, the angles α_{TL} and α_{TR} associated with the antennas 102e and 102i (and the antennas 102h and 102l) will be greater than the corresponding angles associated with the antennas 102f and 102j (and the antennas 102g and 102k). Thus, the top-array antennas at the ends of the drone 10 will point farther to the side (that is, they will be closer to the x-z plane) than the top-array antennas closer to the y-axis. This will facilitate creating radio links with satellites in Layers B, C, and D located at shallower angles. (See FIG. 14.) The angles α_{TL} and α_{TR} are typically equal and are chosen to situate the antennas in the top array pointing generally upwardly away from the surface of the earth for sending radio signals to and receiving radio signals from satellites, a preferred range of α_{TL} and α_{TR} being 0° to 10° at x=0. In the present embodiment d_{TL} and d_{TR} are constant along the length of the casing, but in some instances it may be preferred to maintain the values of α_{TL} and α_{TR} constant along the casing length or vary them according to operational requirements. Conversely, the top-array antennas closer to the center of the drone (such as the antennas 102f, 102g, 102j and 102g) will afford less of an opportunity to form radio links with satellites at such shallower angles. Accordingly, in an optional configuration the top antenna array can include one or more auxiliary antennas 102AX on each side of the drone in addition to the other antennas depicted in FIGS. 1 and 2. The optional nature of these antennas is indicated by their depiction in FIGS. 1 to 3 in dot-two-dash lines.

The side antenna array 104 depicted in FIGS. 1 to 3 is designed to make radio links with other drones in Layer A in FIG. 14. It includes a total of 12 antennas in two rows of six each. A first row of side antennas comprises six lateral-pointing antennas 104a, 104b, 104c, 104d, 104e and 104f located with their mouths centered at equal intervals around the “equator” of the elliptical drone (that is, a line along the drone circumference in the x-z plane). A second row of side antennas comprises six downcast antennas, three of which are located on either side of the drone. The downcast antennas on the left side of the drone are indicated by the reference numerals 104g, 104h and 104j. Each is located with its mouth centered on a line offset downwardly from the line of lateral-pointing antennas, with the center-to-center distance between them being the same as distance between the antennas 104a, 104b and 104c, with each downcast antenna being located one-half the distance between the antennas 104a, 104b and 104c. The downcast antennas on the right side of the drone (not shown) are located in an identical fashion relative to the lateral-pointing antennas 104d, 140e and 104f on that side.

The placement of the antennas in the side array 104 is depicted in FIG. 3, which represents the lateral-pointing antennas as two notional antennas 104L and the downcast antennas as two notional antennas 104D on either side of the drone 10. The antennas 104L point substantially parallel to the surface of the earth along the length of the drone. The centers of the downcast antennas 104D are spaced a circumferential distance d_{S} from the centers of the line of lateral-pointing antennas 104L. Thus, the angle α_{S} between the z-axis and the center of the antenna(s) 104D will increase along the x-axis (in both directions from the origin) as the diameter of the drone decreases (that is, the angles α_{S} associated with the antennas 104a and 104g (and the antennas 104c and 104i) will be greater than the corresponding angles associated with the antennas 104b and 104h. The angle as is preferably chosen to be 5° to 10° at x=0 whereby the lateral-pointing and downcast antennas form a side antenna array pointing horizontally generally parallel to the surface of the earth. In the present embodiment d_{S} is constant along the length of the casing, but in some instances it may be preferred to maintain the value of α_{S} constant along the casing length or vary it according to operational requirements. In a system in which all of the drones are at substantially the same altitude, the side array antennas will provide sufficient antenna beam coverage to establish radio links between a particular drone and nearby drones, via the lateral-pointing antennas, and drones closer to the horizon, via the downcast antennas.

Still referring to FIGS. 1 to 3, the antennas in the bottom antenna array 106 are designed to make radio links with the terrestrial nodes “T” shown in FIG. 14 associated with particular local areas, such as Hawaii, San Francisco, New York and London (used as examples in FIG. 14). There are a total of 12 antennas in the bottom array, arranged substantially the same as the antennas in the top array 102. Specifically, the bottom array includes a total of 12 antennas: four central antennas 106a, 106b, 106c and 106d are equally spaced with the centers of their mouths on a line where the x-y plane intersects the surface of the drone; four more bottom antennas comprising sideways-left-offset antennas 106e, 106f, 106g and 106h are equally spaced with their mouths centered on a line displaced a predetermined distance to the left of the line of central antennas; and four antennas comprising sideways-right-offset antennas (not visible in the drawings) that are equally spaced with their mouths centered on a line displaced a predetermined distance to the right of the line of the central antennas (like top antennas 102i, 102j, 102k and 102l. The center-to-center distance between the antennas in each row of sideways-offset antennas is the same as the central antennas, with each sideways-offset antenna being located one-half the distance between adjacent central antennas. The circumferential placement of the bottom-array antennas in the y-z plane is shown notionally in FIG. 3, which represents the central antennas 106a, 106b, 106c and 106d as a notional antenna 106C, the left-offset antennas 106e, 106f, 106g and 106h as a single notional antenna 106L, and the right-offset antennas as a single notional antenna 106R. In the present embodiment the centers of the left-offset antennas 106L are spaced a circumferential distance d_{BL} from the centers of the line of central antennas 106C, and the right-offset antennas 106R are spaced a circumferential distance d_{BR} from the line of central antennas 106C.

The angle α_{BL} between the y-axis and the center of the antenna(s) 106L will increase along the x-axis (in both directions from the origin) as the diameter of the drone decreases, as will the angle α_{BR} between the y-axis and the center of the antenna(s) 106R, in the same fashion described in connection with the top antenna array 102. Thus, the bottom-array antennas at the ends of the drone 10 will point farther to the side (that is, they will be closer to the x-z plane) than the bottom-array antennas closer to the y-axis. The angles α_{BL} and α_{BR} are typically equal and are chosen to situate the antennas in the bottom array pointing generally toward the surface of the earth for sending radio signals to and receiving radio signals from terrestrial nodes, a preferred range of α_{BL} and α_{BR} being 0° to 10° at x=0. In the present embodiment d_{BL} and d_{BR} are constant along the length of the casing, but in some instances it may be preferred to maintain the values of α_{BL} and α_{BR} constant along the casing length or vary them according to operational requirements. This will provide a sufficiently large area of coverage of the ground to enable the establishment of radio links with multiple terrestrial nodes. Although auxiliary antennas such as 102AX that supplement the top antenna array may be provided at the bottom of the LTA drones 10, the proximity of the drones to the ground (in comparison with the distance to the satellite nodes) should render it unnecessary to increase the surface footprint of the drone's bottom-array antennas.

FIG. 4 depicts in highly schematic fashion the internal components of the LTA drone 10, including internal circuitry that performs route creation and data transmission functions described later in section III. FIG. 4 only schematically represents the top antenna array 102, the side antenna array 104, the bottom antenna array 106 and the solar panels SP for the sake of clarity. Electronic control and communications modules shown in FIG. 4 comprise a central processing unit 210 that includes an operating system module 212, a GNSS (Global Navigation Satellite System) module 214, and a motor/steering/attitude (MSA) control module 216. The operating system module 212 provides overall control of the other system components depicted in FIG. 4, as will be described in the paragraphs that follow just below. The GNSS module 214 enables the drone 10 to determine its position relative to the earth's surface in the manner employed by known global navigation satellite systems, examples being the Global Positioning Satellite (GPS) system based in the United States, the European Union's Galileo system, the Russian GLONASS system and the Chinese BeiDou system. The GNSS module will also serve as a system clock for the routing and data transmission operational phases discussed further below. The central processing unit 210 also controls route creation/data transmission circuitry 310. In an important aspect of the LTA drone 10, the circuitry 310 controls separately operable top antenna route creation/data transmission circuitry 312, side antenna route creation/data transmission circuitry 314, and bottom antenna route creation/data transmission circuitry 316, each of which is dedicated solely to controlling route creation and data transmission via its respective associated antenna array as described in the next following paragraphs. Rechargeable batteries 410 provide operational power to the drone. The MSA module 216 controls the onboard mechanical components mentioned already, which are described in detail next.

Although FIG. 4 depicts the electronic control and communications modules occupying a large amount of the internal volume of the drone 10, in reality they will take up very little space. Most of the internal volume will be occupied by one or more expandable bladders GB (depicted notionally by the long-dash line in FIG. 3) filled with helium or other lighter-than-air gas to maintain the drone at a predetermined altitude. The bladder provides sufficient buoyancy to lift the drone to its operational altitude, at which point they are bled to release a sufficient amount of the helium lifting gas to render the lift L on the drone equal to its weight W. (See FIG. 3.) The entire drone, including the drone casing itself, the hardware and electronic components shown in FIG. 4, and the bladders, will be constructed so that at the desired altitude the coordinates x_{L}, y_{L}, z_{L} of the center of lift CL and the coordinates x_{G}, y_{G}, z_{G} of the center of gravity CG are located relative to each other such that x_{L}=x_{G} and z_{L}=z_{G}, (in the present embodiment x_{L}=x_{G}=0 and z_{L}=z_{G}=0). In the y-direction, the center of lift CL is located at +y_{L} and the center of gravity is located at −y_{G}. In the absence of external forces on the drone, this will urge it to hover at a constant altitude with the x-z plane parallel to the earth's surface, the y-axis normal to the earth's surface, and the bottom antennas pointing down.

In practice, however, most applications will advantageously include a way to maintain the drone level (the x-z plane being parallel to the earth's surface) at the operational altitude, and with the +x direction pointing at a particular heading. The present embodiment incorporates multiple mechanisms for controlling drone attitude (that is, pitch, roll and yaw), as well as for maintaining it at a desired location or, in some applications, steering it in a predetermined flight path. In this description “pitch” refers to angular orientation relative to the z-axis, “roll” to angular orientation relative to the x-axis, and “yaw” to angular orientation relative to the y-axis. “Zero pitch” refers to the attitude in which the x-axis is parallel to the ground; “zero roll” refers to the attitude in which the z-axis is parallel to the ground; and “zero yaw” refers to the attitude in which the x-axis is pointing in the desired heading direction. As already noted, the typical design condition is zero pitch, roll, and yaw, within certain limits that enable its antennas to make radio links with other nodes in the particular communication system in which the drone is deployed.

An important feature of the LTA drone 10 resides in the various mechanical and electromagnetic components 510 that together with the GNSS module 214 and MSA module 216 comprise a guidance and propulsion system for controlling the location and orientation of the drone to maintain it drone in a nominal orientation, wherein pitch, roll and yaw are all zero and the drone hovers at the desired fixed location or follows a desired flight path. The route creation and data transmission methods to be described later in section III depend to a large extent on keeping the antenna arrays in their proper orientation relative to the ground so that they can properly form the intended radio links with other system nodes in the various layers. It is also important to control the location and heading of the LTA drones to provide service to the terrestrial nodes in any particular local area. FIG. 4 identifies these components collectively as an electromagnetic array 512 for heading/yaw control, a servo motor and transmission 514 connected by a top drive shaft 516T and a bottom drive shaft 516B to a top fin 518T and a bottom fin 518B, respectively, and a propeller 520 driven by the servo motor via an axle 522. The servo motor applies torque to the drive shafts 516 to rotate the fins into a desired angle of attack between +β and −β relative to the y-axis (see FIG. 2) under the control of MSA module 216. The transmission enables the fins to be rotated independently throughout their range of motion. The MSA module 216 also controls the rotational speed of the propeller 520.

A first aspect of maintaining/controlling the LTA drone 10 attitude is constructing it and all of its components so that it has a predetermined weight distribution tending to maintain it in level flight (pitch=0°). The pitch angle θ is illustrated in FIG. 5, which is a side view representing a drone weight distribution that biases the drone into an attitude in which θ=0°. FIG. 5 illustrates how, if the drone pitches in either direction, the resulting misalignment of the lift L and weight W creates a moment about the center of gravity tending to return it to level flight (θ=0°). The drone is constructed to maximize the distance along the y-axis between the center of lift CL and the center of gravity CG to maximize the stabilizing moment created if the drone pitches. In addition, the present embodiment also distributes the drone weight to create a moment of inertia that resists forces that would cause its forward end 100F to pitch up (+θ°) or down (−θ°). To that end, and to the extent possible, heavier parts of the drone are located so that the total weight W of the drone comprises a forward auxiliary center of gravity CG_{F} and an aft auxiliary center of gravity CG_{A}, both of which are located in the x-y plane like the overall center of gravity CG and the center of lift CL. Since many of the drone components, such as the antennas, solar panels and bladder, have to be located in the drone according to their functions, the remainder of the weight W is mainly attributable to the rechargeable batteries 410. FIG. 5 reflects the expectation that in most implementations the main contribution to the forward and aft auxiliary weights w_{F} and w_{A}, will be arrangements 412F and 412A, respectively, consisting mostly of the drone's rechargeable batteries. It may be possible to locate other components to contribute to the auxiliary weights w_{F} and w_{A}, but there may be constraints on where they can be located to provide the desired values. Accordingly, it may be necessary to add ballast to achieve the desired effect. For example, in a preferred embodiment the drone is constructed so that w_{F} and w_{A} are equal and with their associated auxiliary centers of gravity CG_{F} and CG_{A} located equal distances x_{Aux} in the x-direction from the drone center of gravity CG. And even so, effective route creation and data transmission can be accomplished even if θ is not maintained at 0°, a preferred range being +10°≥θ≥−10°, with a more preferred range being +6°≥θ≥−6°, although a wider range will still be operational.

The next aspect of maintaining/controlling the LTA drone 10 attitude provides for maintaining its roll angle φ=0° as shown in FIG. 3. As with the pitch angle θ, the alignment in the y-direction of the lift L and weight W inherently biases the drone into an attitude in which φ=0°, as illustrated in FIG. 3 whereby the resulting misalignment of the lift L and weight W creates a moment about the center of gravity tending to return it to φ=0°. In addition, more positive control of the roll angle is achieved by incorporating a tilt sensor (not shown) in the MSA module 216. When the tilt sensor detects a non-zero value of φ, the software in the operating system module 212 and the MSA module 216 cooperate to create a feedback loop that causes the servo motor/transmission 514 to rotate the fins 518T and 518B in opposite directions through the appropriate angles +B and −β to maintain φ=0°. Electronic tilt sensors suitable for the purpose are commercially available, an example being a microelectromechanical system (MEMS) such as the ADIS16201 Programmable Dual-Axis Inclinometer/Accelerometer available from Analog Devices, Inc., One Analog Way, Wilmington, MA 01887.

This method of controlling roll will be effective in situations in which the LTA drone 10 is held in the desired location by a propulsive force PF created by the propeller 520 with the drone's +x-axis pointing in the direction of a prevailing wind PW, thus creating an air flow over the fins 518T and 518B. (Location and heading control are discussed next.) It is anticipated that the drones will be subject to prevailing winds in most situations, making this an effective way of controlling roll under all but unusual atmospheric conditions. Even if the prevailing wind is mild, the inherent tendency of the drone to assume a position in which φ=0° will assist in maintaining it in the desired orientation vis-à-vis roll. And if the GNSS module 214 detects no drone movement, the same tendency should suffice to control the amount of roll, particularly in the absence of any perturbations tending otherwise. Moreover, effective route creation and data transmission can be effected even if φ is not maintained at 0°, a preferred range being +10°≥φ≥−10°, with a more preferred range being +6°≥φ≥−6°, although a wider range will still be operational.

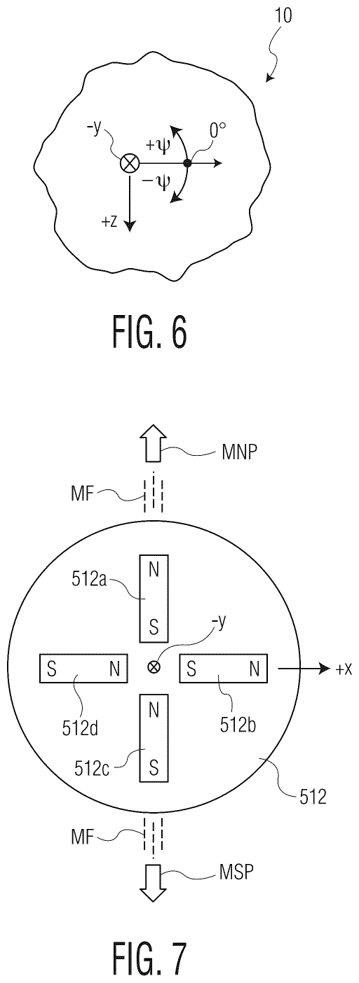

The last aspect of maintaining/controlling the LTA drone 10 attitude and orientation will be described with reference to FIGS. 6 and 7, wherein FIG. 6 is a view taken in the direction indicated in FIG. 5 and FIG. 7 is a detail view of the electromagnetic array 512 labeled “Attitude/Steering Magnets” in FIG. 4. For present purposes, the yaw angle ψ is defined as the amount by which the +x-axis of the LTA drone 10 deviates from a desired heading relative to the surface of the earth. In one implementation, the MSA module 216 can include a suitable device for sensing the orientation of the x-axis relative to the earth such as an ECC-2D Series eCompass from Jewell Instruments, 850 Perimeter Rd. Manchester, NH 03103, to provide a suitable signal to the operating system module of the drone heading. FIG. 7 is a detail view of the electromagnetic array 512 comprising a passive attitude control mechanism for interacting with the earth's magnetic field to control the drone heading.

As seen in FIG. 7, the electromagnetic array 512 viewed in the −y direction. The array comprises four orthogonal electromagnets 512a, 512b, 512c and 512d, with their north and south poles “N” and “S” being oriented as shown when they are actuated. The earth's magnetic field is represented by lines of flux MF. In FIG. 7 the LTA drone 10 is depicted with the magnets 512a and 512c aligned with the earth's magnetic field by virtue of the attraction of their north and south poles to the earth's magnetic north and south poles, respectively. (The earth's north magnetic pole is actually a magnetic south pole, and vice versa for the earth's south magnetic pole.) The drone heading, that is, the direction of the +x-axis, in this orientation is due east. The drone can be brought to any desired heading by an appropriate algorithm resident in the operating system module software 212 in conjunction with the eCompass (not shown) to create a feedback loop that actuates the electromagnets 512a, 512b, 512c and 512d in a predetermined manner to create a rotational force about the y-axis tending to change/maintain the drone heading.

As mentioned, the LTA the drone 10 is typically maintained at a fixed location relative to the earth when used in the communication system described below with reference to FIGS. 12 to 14. Although the preferred deployment altitude is about 10 miles, which places it above the usual maximum nine-mile altitude of the jet stream, the drone will likely be subject to some air currents, as noted. The GNSS module 214 will take periodic readings of the drone location, which will be processed by the operating system module 212 to calculate any nascent drift in the drone's position. A suitable algorithm resident in the operating system module will provide appropriate signals based on the direction the drone has moved from its desired position and its current heading as provided by the onboard eCompass. The operating system module provides appropriate signals to the electromagnets to 512a, 512b, 512c and 512d so that the drone is heading in the proper direction to keep/return it to its desired location via actuation of the servo motor 514 to rotate the shaft 522 and cause the propeller 520 to generate the propulsive force PF. The angle of attack β of the fins 518T and 518B will also aid in keeping the drone's +x-axis facing into the prevailing wind PW with the yaw angle ψ=0°.

In operation, the operating system module 212 receives readings from the GNSS module at appropriate intervals depending on the angular heading of the x-axis at the time, and via a conventional-type feedback loop, controls the propeller, the electromagnets and the angle of attack of the fins to keep the drone pointed in a direction with the +x-axis pointing into and aligned with the prevailing wind direction. It is not necessary to the proper operation on the system that the drone move back to the desired position in a straight line. For example, in a preferred implementation it might “tack” back to the desired position depending on how far it has moved. In the current embodiment the drone is presumed to be facing directly into the prevailing wind when the GNSS module indicates that it has not moved from its desired location. The prolate spheroid shape reduces drag and the amount of power required to maintain the drone in the desired location. In an alternate construction the drone can include wind direction sensors to directly indicate the prevailing wind direction to aid in maintaining the drone in the desired location.

In another implementation LTA drones follow a predetermined flight path designed to increase the number of antenna pairings between them. For example, a circular flight path about 1-2 miles in diameter would change the angles of the drones relative to each other and continuously cause their antennas to point toward each other at slightly different angles. (The flight path may vary slightly from a true circle due to atmospheric conditions.) The operating system module 212 would steer the drone via serial inputs from the GNSS module 214 indicative of the drone location and flight path, as well as from the MEMS tilt sensor and heading information from the eCompass, to control the drone flight path. The MSA control module 216 via the servo motor/transmission 514 will control the fins 518T and 518B and the propeller 520, using selective actuation of the magnets in the electromagnetic array 512 when appropriate. This implementation can also be effected using different flight paths to accomplish the same purpose.

### B. Two Part Lighter-Than-Air Drone

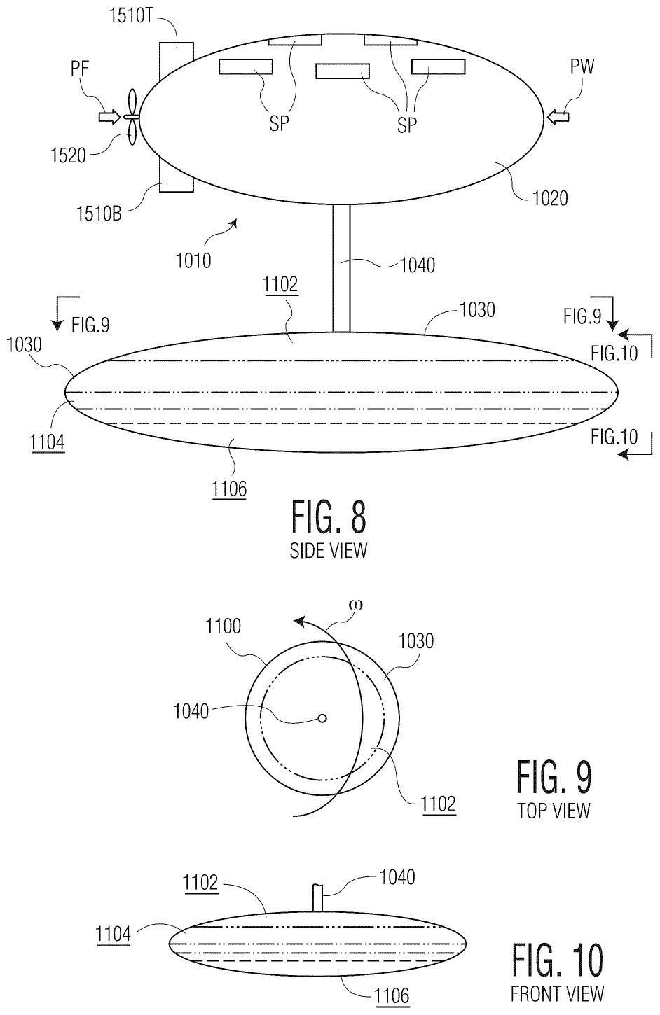

FIGS. 8 to 10 depict a first alternate embodiment comprising a two-part LTA drone 1010 that includes a rigid lighter-than-air upper vehicle 1020 and a communications capsule 1030 connected to the vehicle 1020 by a rod 1040. (Features in the present embodiment with counterparts in the embodiment in FIGS. 1 to 7 are similarly denoted with “1000” series reference numerals.) Bearing structure suitable to the purpose mounts the rod 1040 to the upper vehicle and/or the communications capsule to permit the communications capsule to rotate about the y-axis at an angular velocity ω relative to the surface of the earth. The communications capsule 1030 comprises a regular ellipsoidal rigid casing 1100 symmetrical about all three axes, with an elliptical cross-section in the x-y and y-z planes (FIGS. 8 and 10) and a substantially circular cross-section in the x-z plane (FIG. 9) —geometrically, an oblate spheroid—to present a constant cross-sectional area to any prevailing wind as it rotates. The drone 1010 includes all of the components of the lighter-than-air drone 10 described above in connection with FIGS. 1 to 7. The upper vehicle 1020 carries the solar panels SP, the central processing unit 210, the rechargeable batteries 410 (including any ballast), the mechanical components 510 and a bladder (not shown) to the same purpose as the bladder GB depicted in FIG. 3; the lower communications capsule 1030 houses the communications components, including the antennas and the route creation/data transmission circuitry 310. FIGS. 8 to 10 illustrate schematically the upper antenna array 1102, the side antenna array 1104 and the bottom antenna array 1106. The rod 1040 includes suitable means for connecting the electrical/electronic components in the upper vehicle 1020 and the rotating communications capsule 1030. In an alternate embodiment the tasks of the CPU can be divided between a power CPU in the upper vehicle 1020 that manages the batteries, solar panels and MSA control module, and a communications CPU in the communications capsule 1030 for managing the route creation/data trans-mission circuitry.

Both the upper vehicle 1020 and the communications capsule 1030 include electromagnetic arrays (not shown) like those described above in connection with FIG. 7. The electromagnetic array in the upper vehicle maintains the drone 1010 in a fixed geographic position or steers it along a desired flight path in the same manner and to the same effect described in connection with the LTA drone 10. In an optional non-rotating embodiment the upper vehicle 1020 and the lower capsule 1030 are rigidly attached and the control system can maintain the drone in a fixed location or fly it in a predetermined flight path as with the drone 10. In this embodiment the communications capsule 1030 would not include an electromagnetic array and would preferably be a prolate spheroid with its major axis aligned with the major axis of the vehicle 1020.

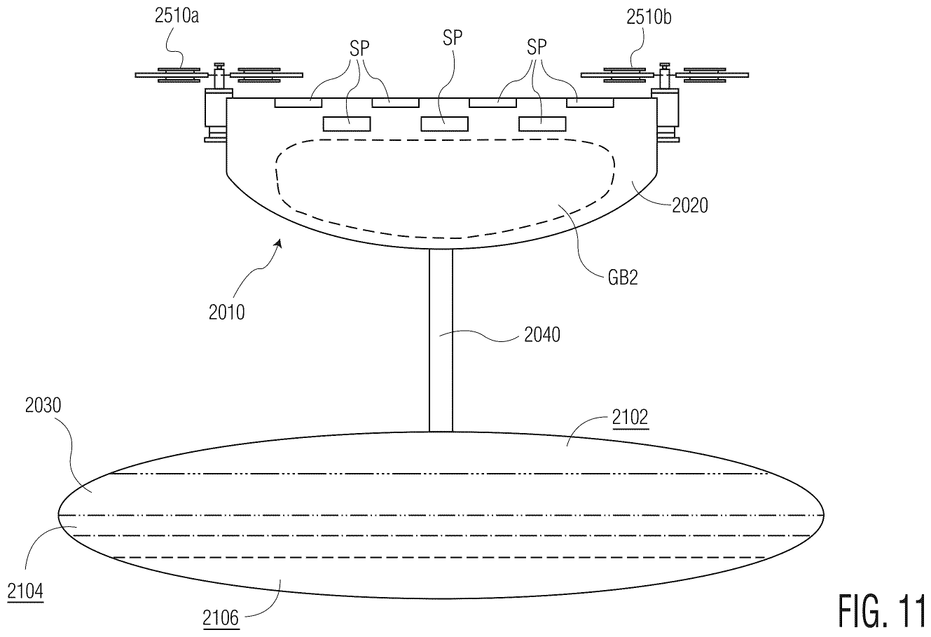

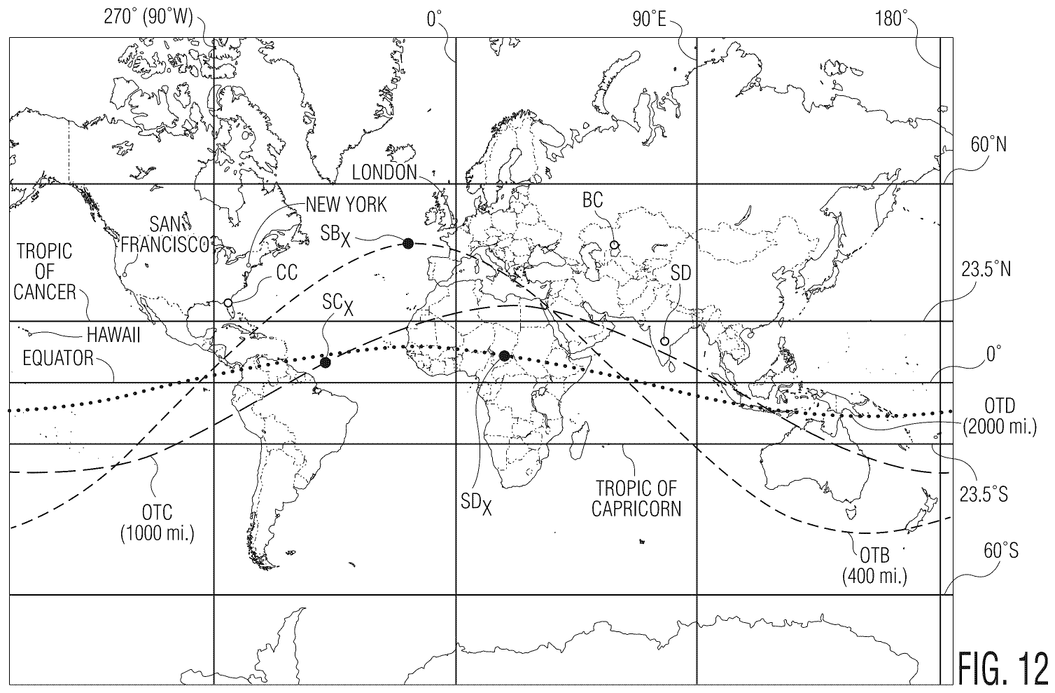

In the rotating embodiment the electromagnetic array in the communications capsule rotates it at an appropriate rate to the purpose of increasing the probability of a transmitted radio beam being received by another drone because the antennas “sweep” an area as the drone rotates. (See FIGS. 11A-11C of U.S. Pat. No. 10,979,136 and accompanying text.) The actual rate of rotation will depend on various factors. If it is too fast, antenna pairings may be too brief to support communications; if it is too slow, the number of antenna pairings during any given time will be decreased. Antenna structure will also affect the optimum rate of rotation, in that narrow-beam directional antennas will be more effective at lower rotation rates, while broader beam antennas will support higher rotation rates. A preferred range of @ is believed to be from one to three revolutions per minute, although a wider range will likely still be operational. In addition, the masses of the rechargeable batteries and any ballast are located in the communications capsule 1030 in the same manner and to the same effect as in the LTA drone 10, described above in connection with FIG. 5.

### C. Two Part Heavier-Than-Air Rotary-Wing Drone With Optional Lift Assist

FIG. 11 is schematic side view of a second alternate embodiment of a drone 2010 for use as a type A node in the system described with reference to FIGS. 12 to 14. The drone 2010 comprises a two-part non-orbiting aerial node in which the communications capsule in FIGS. 8 to 10 is suspended from a heavier-than-air rotary-wing aircraft (HTA drone) with optional lift assist provided by a lighter-than-air gas.

The HTA drone 2010 includes a heavier-than-air rotary-wing vehicle 2020 from which a communications capsule 2030 with a rigid casing is suspended by a rod 2040 that connects the vehicle 2020 and the communications capsule 2030. (Features in the present embodiment with counterparts in the embodiment in FIGS. 1 to 10 are similarly denoted with “2000” series reference numerals.) As in the second embodiment in FIGS. 8 to 10, the vehicle 2020 carries the solar panels SP, the central processing unit 210, the rechargeable batteries 410 (including any ballast) and mechanical components analogous to the components 510 in a manner described in the next paragraph; the communications components including the antennas and the route creation/data transmission circuitry 310 are housed in the communications capsule 2030. FIG. 11 illustrates schematically the upper antenna array 2102, the side antenna array 2104 and the bottom antenna array 2106. As described in connection with the drone 1010, the tasks of the CPU can be divided between a power CPU in the upper vehicle 2020 and a communications CPU in the communications capsule 2030.

The drone 2010 is in most operational aspects the same as the lighter-than-air embodiment in FIGS. 8 to 10, but structurally the heavier-than-air rotary-wing vehicle 2020 replaces the lighter-than-air upper vehicle 1020. In a preferred implementation the rotary-wing vehicle will comprise four rotors and their electric motors 2510 located 90° apart when viewed from the top (Two of the motor/rotor units 2510a and 2510b are seen in FIG. 11.) Location, altitude, orientation and flight path are controlled by inputs to the rotor/motor units 2510 analogous to the inputs to the fins 1510a and 1510b and propeller 1520 on the upper vehicle 1020 by the mechanical components 510 of the embodiment shown in FIGS. 8 to 10.

In one implementation the drone 2010 is maintained in a fixed geographic position to the same effect as the LTA drones. In that instance, the operating system module processes inputs from the onboard GNSS circuitry and MSA module to detect movement of the drone 2010 from a desired position and actuate the servo motor and transmission module to control the rotor/motor units and keep the drone essentially stationary in a fashion analogous to that used to control the fins and propeller motor in the previous embodiments. Similarly, the rotors can be also used to steer the drone in a desired flight path. In an embodiment in which the upper vehicle and lower capsule are rigidly attached, the rotors can be controlled to rotate the entire drone about its y-axis to the same effect as the embodiment shown in FIGS. 8 to 10. In still another construction, the rod mounts the communications capsule for rotation relative to the upper vehicle in the same fashion as in the drone 1010. The rotary-wing upper vehicle provides more operational alternatives than a drone with a lighter-than-air upper vehicle. For example, in a construction with the upper vehicle and lower capsule rigidly attached the control system can maintain the drone in a fixed position or fly in a predetermined flight path. Or the rotary-wing vehicle 2020 can be rotated bodily about its y-axis to the same effect as described above, either while stationary or in motion. In another variation the upper vehicle and the communications capsule are mounted in the same manner as in the drone 1010 to permit them to rotate relative to each other. The communications capsule can be rotated by using the electromagnetic array as in the drone 1020 while the upper vehicle 2020 is maintained stationary or is steered in a predetermined flight path. The communications capsule is preferably a prolate spheroid in nonrotating applications, in which the x-axis will be maintained in alignment with the prevailing wind, and an oblate spheroid in rotating applications.

An important feature of the present embodiment is the incorporation into the upper vehicle an optional expandable bladder GB2 containing helium or other lighter-than-air gas. The gas provides a predetermined amount of buoyancy to the drone 2010 to reduce the amount of power required to keep it at a desired altitude. In a preferred embodiment, it will maintain the drone at a minimum design altitude for a given application, which will permit the drone to use more power to raise it to higher altitudes as desired. For example, a given system may be designed for multiple groups of type A nodes (see FIG. 14) at different altitudes. If a certain number of higher altitude drones are lost through failure, hostile action or otherwise, they can be replaced by some of those at lower altitudes by applying more power to their rotor/motors. The use of lighter-than-air gases to provide lift assist to the drone 2010, while optional, will reduce the amount of power required by the rotor/motors to perform their functions described above.

### III. Route Creation in Systems with Orbiting/Non-Orbiting Aerial Nodes

For reference in the descriptions that follow of the use of drones according to the present description, Table 1 sets out for orbiting and non-orbiting aerial nodes of different altitudes their distances to the horizon (DH) and footprints. To avoid interfering with commercial aviation, drones and balloons must be above about 10 miles; by FAA regulation, drones can also fly below 400 feet as long as they are not in otherwise restricted airspace, such as near an airport.

TABLE 1

| | Distance to | Footprint - |
|---|---|---|
| Altitude - AL | Horizon - DH | π*DH² |
| (miles) | (miles) | (sq. mi.) |
| ≤400 ft. (drone) | | |
| 10-20 (drone) | 280 ≤ DH ≤ 400 | 250,000 ≤ FP ≤ 500,000 |
| 100 | 900 | 2,500,000 |
| 200 | 1,280 | 5,100,000 |
| 400 | 1,830 | 10,500,000 |
| 500 | 2,000 | 12,500,000 |
| 800 | 2,600 | 21,200,000 |
| 1000 | 3,000 | 28,300,000 |
| 22,230 | 26,000 | 2.1 × 10⁹ |
| (Geostationary) | | |

This table illustrates trade-offs involved in designing communications using only orbiting satellites as system nodes. The distance to the horizon and the corresponding footprint increase as the satellite altitude increases, potentially providing wider coverage with fewer satellites, but the strength of the radio signals between the satellites and the ground is attenuated as their altitude increases. The following discusses how combining a constellation of orbiting satellites with a plurality of non-orbiting aerial nodes, particularly drones according to this disclosure, can improve the performance of satellite-based long distance communications and provide service in local areas without relying on the satellites.

### A. General Description of Exemplary Satellite Deployments

FIG. 12 illustrates various forms that a constellation of satellites, such as those just described above, can assume for implementing such a system. This figure is based on a standard Mercator projection of the earth showing the equator, the Tropic of Cancer, and the Tropic of Capricorn. FIG. 12 illustrates exemplary systems comprising multiple satellites at different altitudes and orbital inclinations that can be used in a multi-level, orbiting/non-orbiting node communications system described below with reference to FIG. 14, which includes a layer A of non-orbiting nodes and three layers B, C and D of satellite nodes orbiting at different altitudes in orbital tracks at different inclinations. An orbital track OTB shown in a short-dash represents a satellite SB_{X} deployed into a 400-mile altitude circular orbit from launch site BC at 45°N lat. A second orbital track OTC shown in a long-dash line represents a satellite SC_{X} deployed into a 1000-mile altitude circular orbit from launch site CC at 28°N lat. A third orbital track OTD shown in a dotted line represents a satellite SD_{X} deployed into a 2000-mile altitude circular orbit from launch site SD at 13°N lat. These are meant to be examples of orbital tracks that satellites in the present system can assume; for example, a particular layer could include satellites in different orbital tracks.

The satellites in the orbital tracks will process, so that after a certain time they will appear to an observer on the ground to be randomly (stochastically) distributed in the sky. The length of time required to achieve stochastic distribution can be reduced by judiciously timing the deployment of the satellites in each orbital track, for example, by deploying satellites in a particular orbital track at substantially equal intervals. Although it may be theoretically possible using a sufficiently sophisticated algorithm to predict, or at least estimate, the satellites' locations as a function of time and thus predetermine deployment timing, it is not necessary in the present system to predict their locations relative to each other. That is because as a stochastic system it relies on probabilities to establish radio links between different aerial nodes and between aerial nodes and ground nodes.

The probabilistic nature of creating routes via one or more satellites through a constellation of plural satellites in unconstrained, stochastic orbits relies on the number of satellites are likely to be within sight of a given point on the earth's surface at any given time. To illustrate the statistical principles underlying such a system, consider a constellation of 100 satellites in the orbital path OTB at an altitude of 400 miles. The satellites cover an area of the earth between 45°N lat. and 45°S lat. This is about 140,000,000 sq. mi., or roughly 70% of the earth's surface of about 200,000,000 sq. mi. The satellites in this orbital track have a footprint of about 10,000,000 sq. mi. (Table 1; 400-mile high orbit), represented by a long-dash line in FIG. 4. Thus, each satellite in orbital track OT4 in that swath will “cover” about 7.1% of the swath (10,000,000 sq. mi.÷140,000,000 sq. mi.), so that on average any one point on the surface that is about 1,800 miles (Table 1; DH=1,830 mi.) from the outer extent of the orbital path will “see” at least seven of the 100 satellites (100×0.071). (By the same token, a satellite will see 28 other satellites; see Table 1.) Since establishing communications with the stochastically distributed satellites is based on probabilities, the system considers that the chance that a satellite will not be visible from any point in that region is 92.9%. However, in a constellation of 100 satellites, the probability that any particular ground location in that region will not be able to see at least one satellite is only 0.929¹⁰⁰≈6.3×10⁻⁴ (that is, about one in 1,600). Locations on the surface closer to the northern and southern boundaries of the orbital swath (in this example 45°N lat. and 45°S lat.) will see fewer satellites, but the probability of making connections with ground stations in such locations is still sufficient to support the immediate creation of multiple satellite-to-ground radio links with those ground stations. In addition, the system is fully scalable by adding satellites to the constellation to increase the probabilities of immediate creation of a radio link between a satellite and any given ground station.

An important factor in assembling a multi-satellite radio route is the number of other satellites that any given satellite can “see.” Referring to Table 1, a satellite in any orbital path can theoretically see other satellites over the horizon up to a distance of 2×DH. In the example in the preceding paragraph, each satellite in a 400-mile orbit can theoretically “see” about 3,660 miles over the horizon (2×1,830 mi.), but interference from ground structures at the horizon may reduce that distance, so that 3,500 miles would be a more conservative estimate. Accordingly, a first satellite receiving an initial routing signal from a sending ground station can on average see a very large number of other satellites within the swath covered by the constellation (extending between 45°N lat. and 45°S lat.) that can potentially receive routing messages from the first satellite, and satellites receiving those routing messages will be able to send further routing messages to a large number of other satellites within the swath up to 3,500 miles away, and so on. An object of the satellite configurations, routing protocols, ground station constructions, and system architectures described herein is to take advantage of this property to ends to be described. Other important characteristics of the disclosed systems and methods include, but are not limited to, the ability to be scaled up in complexity by incorporating more satellites and other types of aerial nodes at different altitudes, the ability to accommodate a wide variety of aerial node deployment strategies, and the ability to compensate for aerial node attrition, such as by orbital decay, node failure and hostile action.

An important feature of the system is the ability to create radio links and assemble them into optimum routes via the routing protocols described in the next subsection when terrestrial nodes don't know the positions of the aerial nodes (whether orbiting or non-orbiting) and the aerial nodes don't know the positions of other aerial nodes. By its nature the system may not always be able immediately to create a route connecting a particular pair of terrestrial nodes, but judicious selection of the placement and number of directional antennas on the aerial and terrestrial nodes should yield a 90% probability of success in creating a route during a given route creation phase.

### B. Local and Wide Area Routing Systems and Methods

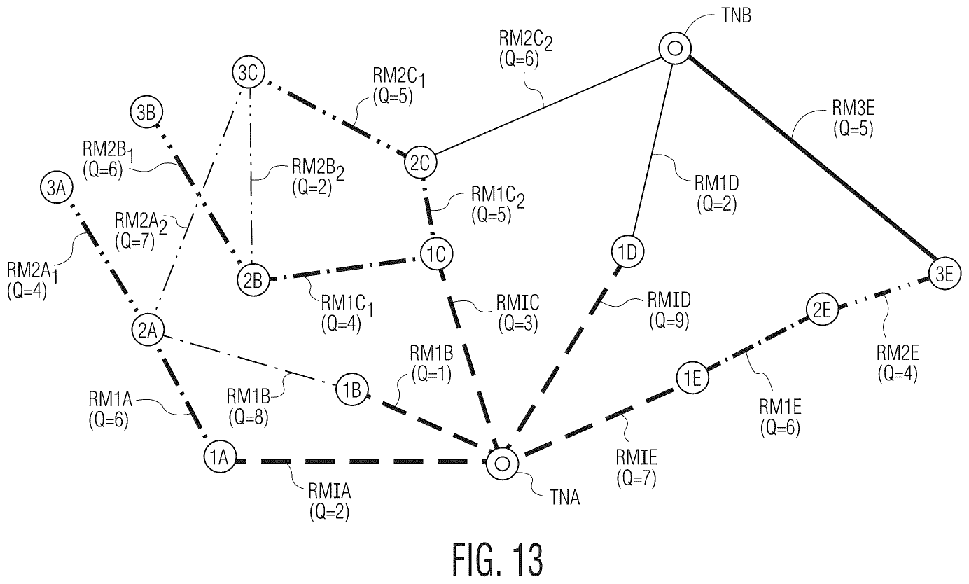

FIG. 13 is used to describe one embodiment of a protocol for creating optimum radio routes through a system comprising just non-orbiting aerial nodes (“local area data transmission”) and a system with multi-level, orbiting/non-orbiting nodes described further below with reference to FIG. 14 (“wide area data transmission”).

### 1. Local Area Data Transmission Using Drones

In one embodiment route creation is carried out separately for routes involving only drones (“local area routing”) and for routes involving drones and one or more layers of satellites (“wide area routing”). FIG. 13 is a schematic diagram illustrating a local area routing network comprising radio links created to transmit data to a terrestrial node in a system comprising plural non-orbiting aerial nodes such as those depicted in FIGS. 1 to 11. The manner in which the routing protocol is adapted for transmitting data over longer routes including satellites in a constellation like that in FIG. 12 is described in the next subsection.

FIG. 13 uses as example five first tier nodes 1A, 1B, 1C, 1D and 1E that received initial routing messages RMI from a sending terrestrial node TNA. A typical terrestrial node will have a plurality of antennas for sending initial routing messages in multiple directions around the surrounding hemispherical space. In the drawing the initial routing messages are referred to by the reference “RMIX,” where “X” is the first tier nodes that received the initial routing message. In an actual system there might be many more nodes that receive initial routing messages. The quality Q of each initial routing message, as determined by the receiving first tier node, is given in parentheses with each routing message. The quality Q is a quantitative parameter that indicates the desirability of a radio link between two nodes for supporting internodal data transmissions as described further below. In the present system Q is the measured signal strength. Other implementations are possible, such as including error coding data in a routing message and then assessing the extent to which the routing message includes erroneous data. However, measured signal strength is one preferred parameter because it does not require including additional data in the routing messages that will increase the bandwidth, power, and time required for their transmission.

In a subsequent interval all of the first tier nodes send first tier routing messages on all of their antennas. The first tier routing messages include the terrestrial node address information in the received initial routing message and the quality of the received initial routing message. A node receiving a first tier routing message is referred to as a “second tier node.” The drawing shows four second tier nodes 2A, 2B, 2C, and 2E. Consistent with the terminology noted above, the first tier routing messages are referred to by the reference “RM1X,” where “X” is the second tier node that received the first tier routing message. Routing messages received by second tier nodes are indicated by dash-one-dot lines. Each second tier node notes the identity of the antenna on which it received the first tier routing message and determines the quality Q of the received first tier routing message.

FIG. 13 illustrates the routing protocol in the event a node such as the second tier node 2A receives two first tier routing messages that identify the same terrestrial node. Say node 2A received a first tier routing message RM1A on antenna A_{X} and a first tier routing message RM1B on antenna A_{Y}. Although RM1B has a higher quality (Q=8) than RM1A (Q=6), a route to the terrestrial node TNA through the node 1B would include link RMIB with a quality Q=1. Applying the principle that “a chain is only as strong as its weakest link,” the node 2A will store the antenna A_{X} on which it received the first tier routing message RM1A (Q=6) since the other potential route to the terrestrial node TNA would include the link RM1B with a lowest quality (Q=1), even though the sums of the qualities of the links RMIB (Q=8) and RM1B (Q=1) is higher. That is, the node 2A discards (doesn't store) the antenna on which it received a routing message with the lowest quality (lowest signal strength) from among the initial and first tier routing messages, and stores the identity of the antenna receiving the other first tier routing message. The stored Q is called the “highest first tier quality.” FIG. 13 indicates the subroute selected by the first tier node by the heavy dash-one-dot line denoting the link established via the preferred first tier routing message RM1A. Discarded potential links are denoted by non-bold dash-one-dot lines. The second tier node stores the identity of the chosen antenna A_{X}, the quality Q of the lowest quality routing signal (RMIA) received on that antenna (Q=2), and the address information of the terrestrial node TNA to which that antenna has a route.

The second tier nodes then send second tier routing messages on all of their antennas. A second tier routing message will include the terrestrial node TNA address information and the lower of the qualities Q of the respective initial and first tier routing messages linking the first and second tier nodes and the first tier node and the terrestrial node TNA. In FIG. 13 the second tier routing messages are referred to by the reference “RM2X,” where “X” identities a node (“third tier node”) that received a second tier routing message.

Third tier nodes that received second tier routing messages process them in a manner depicted in FIG. 13. Taking as a first example, two of the second tier routing messages sent by the node 2A are received by two respective third tier nodes 3A and 3C. The node 3A received the second tier routing message RM2A₁ and the node 3C received the second tier routing message RM2A₂. Since the node 3A only received the second tier routing message RM2A₁, it stores the identity of the antenna on which it received the routing message RM2A₁ and associates the address information of the terrestrial node TNA with that antenna. The potential links established via the second tier routing messages are denoted by dash-two-dot lines, with chosen links in bold.

The node 3B received the single second tier routing message RM2B₁, and thus has only one potential route to the terrestrial node TNA. The node 3C received three second tier routing messages: RM2A₂, RM2B₂, and RM2C₁ (from second tier node 2C). The routing message RM2A₂ includes the quality (Q=2) of the initial routing message RMIA, as explained above. The second tier routing message RM2B₂ from the node 2B includes the quality (Q=3) of the initial routing message RMIC sent from the node 1C to the node 2B, since that is the lower of the qualities Q of RM1C₁ (Q=4) and RM1C (Q=3). The routing message RM2C₁ from the node 2C includes the quality (Q=3) of the initial routing message RMIC from the node 1C to the satellite 2B, since that is the lower of the qualities Q of RM1C₂ (Q=5) and RM1C (Q=3). The node 3C determines the quality of each of the received second tier routing messages and the qualities of the weaker links through the second and first tier nodes to the ground station. The node 3C thus chooses the subroute through the node 2C established by RM2C₁ because the lowest quality in the links back to a first tier node via that route is Q=3 (RMIC), as compared to Q=2 for both of the routing messages RM2B₂ and RMIA. The node 3C stores the antenna on which it received the second tier routing message RM2C and the address information of the terrestrial node TNA.

The principle underlying the choice of preferred radio subroutes back to the sending ground station from third tier nodes can be stated in general terms via an understanding of the algorithm used by the node's route creation circuitry to choose a preferred third tier routing message on which to base the subroute. The route creation circuitry of each third tier node makes two determinations. One, it determines the quality of each second tier routing message received from a respective second tier node and matches it with the lower link quality included in the associated second tier routing message: RM2A₂ (Q=7) matched with RMIA (Q=2); RM2B₂ (Q=2) matched with RMIC (Q=3); and RM2C₁ (Q=5) matched with RMIC (Q=3). Two, it identifies a preferred second tier routing message representing a second subroute from the third tier node to the terrestrial node TNA via a first tier node. This second subroute comprises a third radio link between the third tier node and the second tier node associated with the preferred second tier routing message. In this instance, the preferred third tier routing message is RM2C₁ because all of its links have a higher quality than any first, second, or third radio link associated with any other received second tier routing message; that is, the links in the subroute through RM2C₁, RM1C₂ and RMIC all have qualities higher than the lowest quality link in the other possible subroutes (Q=3 for RMIC vs. Q=2 for RMIA and RM2B₂). The node memory stores the identity of the antenna on which the preferred third tier routing message was received and the associates it with the terrestrial node address information in the third tier routing message.

Next, the third tier nodes send third tier routing messages on all of their antennas. A third tier routing message will include the terrestrial node address information and the lowest quality Q included in the received second tier routing message associated with the address of the sending terrestrial node TNA.

Then, all of the terrestrial nodes in the system analyze all of the routing messages they have received. FIG. 13 illustrates a terrestrial node TNB that received a first tier routing message RM1D (Q=2) from the node 1D, a second tier routing message RM2C₂ (Q=6) from the node 2C, and a third tier routing message RM3E (Q=5) from the node 3E. Using the same algorithm as the nodes, the receiving terrestrial node TNB selects the antenna that received the routing message RM3E since the other potential routes (indicated by light solid lines in FIG. 13) include links with qualities lower than the lowest of all of the link qualities of the received third tier routing massages and the respective link qualities included in them. The terrestrial node TNB stores the identity of the selected antenna (the one that received the “highest” quality third tier routing message RM3E) and associates with it the address of the sending terrestrial node TNA in that third tier routing message RM3E. The selected link is indicated by the heavy solid line in FIG. 13. In a system with 50 terrestrial nodes, this routing method can result in up to 2,450 routes connecting every terrestrial node to another terrestrial node.

The route thus established permits data at the receiving terrestrial node TNB, sometimes referred to as an “originating terrestrial node” in reference to its role as the point at which data transmission originates, to reach the sending terrestrial node TNA, sometimes referred to as a “destination terrestrial node” since it is the destination of the data. Because of the manner in which the quality parameter Q is measured, the route is automatically the best one between the terrestrial nodes in terms of signal strength. Route creation does not require the nodes to be in precise orientations (fixed pitch, roll and yaw) or at the same altitudes or at known locations, because the top, side and bottom antenna arrays can transmit and receive signals over most of the spherical space surrounding the node. That underpins the probabilistic nature of the routing process by which any one node will likely receive radio signals from other nodes—even though no node knows the location of any other node. The routing protocol depicted in FIG. 13 automatically chooses node-to-node links that create an optimum route. As already noted, this construction, along with unique routing methods, makes the drones light, inexpensive and easy to deploy. The same routing protocol is applied to route creation involving satellites in stochastic orbits, as discussed later.

This summarizes how data is transmitted from TNB to TNA after antenna selections are made according to the routing protocol described above in connection with FIG. 13:

| ROUTE CREATION PHASE | DATA TRANSMISSION |
|---|---|
| (Read Down) | (Read Up) |
| 1. RME1 w/TNA addr. rec'd. | 4. Data addr. to TNA |
| on antenna E1_{X} | transmitted on E1_{X} |
| 2. RME1 w/TNA addr. rec'd. | 3. Data addr. to TNA |
| on antenna E2_{X} | transmitted on E2_{X} |
| 3. RME2 w/TNA addr. rec'd. | 2. Data addr. to TNA |
| on antenna E3_{X} | transmitted on E3_{X} |
| 4. RME3 w/TNA addr. rec'd. | 1. Data addr. to TNA |
| on antenna TNB_{X} | transmitted on TNB_{X} |

In one implementation a route creation/data transmission cycle will last four seconds with a one second route creation phase. It is believed that a particular route will remain sufficiently stable long enough for a three second data transmission phase before aerial nodes in the system have moved, breaking radio links between some of them and requiring a new route creation phase. In a variation an entire cycle would take 1.0 sec, with a route creation phase lasting 0.33 sec followed by a data transmission phase lasting 0.33 sec. The remaining time would be “quiet,” with no radio signals being sent by any nodes. This would reduce power requirements and increase battery life, and also make more difficult to find and destroy the aerial nodes. Greater weight reduction can be achieved by introducing a pause between successive route creation/data transmission cycles. For example, if a quiet time of 20 to 30 seconds were introduced between successive cycles, the power required by a drone (or balloon) could be reduced by an order of magnitude or possibly more, with a concomitant weight reduction due to the need for fewer solar panels and batteries. It is estimated that continuous route creation/data transmission could require a prolate spheroid drone with a major x-axis of 20-30 ft. and a maximum diameter of 5-6 ft. Introducing a 20-30 second pause between cycles could allow a major axis of only 3-5 ft. with a maximum diameter of 2-4 ft. due to a resulting reduction in bladder size. Comparable size reductions would be possible for embodiments including oblate spheroid communications capsules.

### 2. Wide Area Data Transmission Using Drones and Satellites

The routing protocol described above is used in modified fashion to create routes that include non-orbiting nodes and orbiting satellites in a constellation such as that depicted in FIG. 14. A multi-level system with the following architecture is an example of a system that supports local area and wide area data transmission.

Referring to FIG. 14, a multi-layer system comprises aerial nodes in layered cohorts in the following fashion:
Layer/Cohort A: Drones and/or balloons below an altitude of 400 ft., or balloons and/or drones at altitudes of 10-20 miles. In the embodiment here, drones are maintained in fixed locations as discussed earlier.
Layer/Cohort B: Very low earth orbit (“VLEO”) satellites at altitudes of 200-400 miles. These satellites will see decaying orbits due to aerodynamic drag, but will retain their usefulness in the system until their orbits decay to about 100 miles in altitude.
Layer/Cohort C: Low earth orbit (“LEO”) satellites at 800-1000 miles.
Laver/Cohort D: Satellites orbiting above 2,000 miles. In some applications, geostationary satellites can be included in this layer.

The downward pointing antennas 106 of the drones form radio links with terrestrial nodes in its coverage area; the sideways pointing antennas 104 permit routing and data transmission with other drones; and the upward pointing antennas 102 receive and transmit signals to the next level up, in this case layer B satellites. The drones optimize this internodal communication paradigm by distributing the computing load involved in route creation and data transmission, thus enabling the system to handle significantly more traffic between the terrestrial nodes participating in the system at any given time. Route creation and data transmission between terrestrial nodes, between nodes in a given layer, and nodes in different layers is performed by an adaption of the protocol described with reference to FIG. 12, as explained in more detail in the '796 publication and summarized below. However, the drones handle route creation and data transmission tasks using the separate route creation/data transmission modules 312, 314 and 316 in accordance with the nature of the signals received by the antennas in the array with which they are associated. This relieves the central processing computer 210 in the drone of much of the computing load involved in the complex routing and data transmission protocols described in the '796 publication.

This routing approach in effect treats users, nodes, route creation, route usage, and route timing as being in different complex frequency bands, complex different altitude ranges, and complex different geographic areas. The following describes a system that uses these concepts to provide a practicable worldwide system for transmitting data or supporting telephone call over long distances among terrestrial locations all over the world. FIG. 13 depicts an exemplary system representative in which aerial nodes occupy respective levels “A,” “B,” “C,” and “D,” generally comprising four more or less distinct layers at different altitudes. One feature of this type system is that it employs low-altitude, non-orbiting aerial nodes, advantageously comprising the LTA and/or HTA drones described here, to service local clusters of ground nodes, while automatically transitioning to higher and higher altitude satellite nodes at levels B, C, and D for multi-layer communications routes over longer and longer distances. While this exemplary system comprises four layers of aerial nodes, it can also be readily implemented with a different number of layers, either more or fewer. In that regard, the number of layers would be partially dictated by the anticipated amount of traffic. The percentage of traffic destined for far-distant locations versus local traffic would also be important in the decision of how many layers to utilize for any given route. The routing protocols discussed here and in the '796 publication permit the satellite cohorts to route easily among themselves, as in the exemplary implementation described there, which illustrates novel decision rules and methods by which the nodes themselves decide whether routing messages are directed toward nodes in a different layer (up or down) or in the same layer. Data transmissions thus also travel in routes that can have links between nodes in the same layer or in different layers.

The drones may all be at substantially the same altitude as shown in FIG. 8 or occupy a range of altitudes, depending on system requirements or the local surface topography. This proximity to the ground has two important advantages. The first is that it strengthens the signal strength between the drones and the ground, in the manner of cellular radio base station-to-consumer device links. This provides sufficient signal strength to penetrate obstacles such as automobile tops and the roofs of buildings. It also enables the use of highly focused antennas, which will permit different antenna beams to work with different users in close proximity to each other. Techniques such as spread spectrum modulation (i.e., code division multiple access) can also be used to minimize crosstalk between individual users.

In FIG. 14 the type A drones are denoted by the letter “A” followed by a letter representing the local area (“H” for Hawaii, “S” for San Francisco, “N” for New York, and “L” for London, England), and a numerical indicator signifying it as a particular one of the drones in the particular local area. For example, AH2 and AH42 represent drones no. 2 and no. 42 in a local area covering Hawaii; AS26 and AS12 represent drones no. 26 and no. 12 in a local area covering San Francisco; AN26 and AN40 represent drones no. 26 and no. 40 in a local area covering New York; and AL8 and AL38 represent drones no. 8 and no. 38 in a local area covering London. For the sake of clarity, FIG. 12 only depicts a representative number of the drones in each local area.

Type B satellites cover a larger area that in a typical implementation will permit the creation of routes between drones in different local areas. The satellites need downward pointing antennas capable of finding type A nodes (drones), sideways pointing antennas for linking with other type B satellites, and upward pointing antennas for receiving and sending routing messages (and data transmissions) to type C satellites. The satellites are denoted by the letter “S” followed by a layer designation (“B,” C,” or “D”) and a number of an individual satellite. For example, from left to right FIG. 13 depicts satellites SB101, SB82, SB65, SB71, SB156, SB181, and SB92. The system will include a sufficient number of satellites in stochastic orbits to provide a sufficient probability that links among the nodes at different levels can create the desired routes in a particular allotted time. It is anticipated that a constellation of 200 satellites in cohort B will support the multi-level routing protocols described herein. Type B nodes can also comprise satellites maintained in preplanned fixed-orbits.

Type C satellites orbit at altitudes of 800-1000 miles. If the satellites are in uncontrolled, stochastic orbits, they can be deployed at different altitudes within this range. This satellite cohort will be useful for routing over intermediate distances in order to enable route creation between different B layer satellites. They need horizontal antennas for routing with other layer C satellites, upward-pointing antennas for connecting to type D satellites in higher orbits, and downward pointing antennas for connecting to type B satellites. It is anticipated that a constellation of 50 satellites in cohort C will support the routing protocols described here. The naming convention described above is also used for layer C satellites, with satellites SC45, SC26, SC32, SC12, and SC6 denoting five of the satellites in this cohort.

Type D satellites are limited in number and are useful for creating links between C layer satellites to support long-distance communications, such as intercontinental data transmissions. Satellites in equally spaced polar orbits forming a grid over the earth's surface like certain satellite designs now in mass production could also be of value. Most systems would require a limited number of type D satellites, and their design will preferably be dictated by anticipated traffic loads. They need sideways pointing antennas and downward pointing antennas. The distance between them could be large, but because of their height above the earth, they will have a very long line of sight over the horizon presented by the curvature of the earth. It is anticipated that about ten satellites in cohort D will be sufficient to support the present multi-level protocol. FIG. 14 depicts three of the satellites SD9, SD2, and SD5.

Creating routes from one particular terrestrial node to another employs a zip code paradigm employing a “zone designation” of five digits {x1, x2, x3, x4, x5} to identify the zones or areas served by the different aerial node cohorts. The first digit designates wide-area regions that will be used in the routing protocol when a routing message is directed to a D layer satellite in accordance with the routing protocol described herein. (It is roughly akin to a U.S. region identified by the first digit of a postal zip code.) The following are examples of wide-area regions covering the globe designated by the digit x1:
x1=1: Europe incl. Great Britain to 60° W longitude (excludes India)
x1=2: Eastern Eurasia, China, and Pacific Oceana north of the equator
x1=3: North America and Atlantic Oceana north of the equator
x1=4, 5, 6: Regions of approximately equal area in a band north of the equator to about 30° N latitude, including Mexico, northern Africa, India, and Southeast Asia
x1=7, 8, 9: Regions of approximately equal area including South America, Atlantic Oceana south of the equator, Sub-Saharan Africa, Indian Oceana, and Pacific Oceana south of the equator.

The next digit x2 represents subregions within each wide-area region participating in the routing protocol. The subregions are associated with the C layer satellites, which allows for up to ten subregions (x2=0 to 9) for each wide area region. The next digit x3 represents extended local regions within each subregion. The extended local regions are associated with the B level satellites, which allows for ten extended local area regions (x3=0 to 9) within each subregion. The final two digits (x4, x5) designate individual drones in a local area, thus permitting the use of up to 100 drones (x4, x5=00-99) in a local area network. The drones and the satellites each store a look-up table with the longitudinal and latitudinal boundaries of the wide-area regions, the subregions, and the extended local areas. Like the drones, the satellites also include GNSS circuitry that indicates the longitude and latitude of the satellite at any given time, whereby an airship or satellite determines its location expressed in terms of the three-digit zone designation.

Route creation involving drones and satellites in one or more of the layers B, C and D, involves populating look-up tables in each airship and satellite of the identity of the antenna to use to send radio signals to nodes in an adjacent level. That is, each drone will store the identity of the antenna that provides the link with the best composite quality to a satellite in the B layer via an adaption of the routing protocol described above with reference to FIG. 13. Conversely, the B layer will have stored the identity of its antenna associated with that link. Likewise, the satellites in the C and D layers will also know the antennas associated with the best quality links between each of them in both layers. Accordingly, each of the A, B and C layers will know the antenna to use to transmit data to an adjacent layer. If there are no drones within sight of a B level satellite in the local area region it occupies during a route creation interval—for example in a remote area or on a small island—a route is created to the satellite directly from any terrestrial node in that region in a manner analogous to that described above regarding creating links between drones and B level satellites. The '796 publication at paragraphs 0170-0183 describes in more detail a route creation protocol used to create interlayer links.

### 3. Examples of Local Area and Wide Area Routes

FIG. 14 depicts several examples of high-capacity local-, medium- and long-range routes for data transmissions that can be expeditiously created by employing drones in a four-tier satellite/drone system. FIG. 14 shows all of the drones at the same 10-mile altitude, as noted in the figure. For convenience of reference, the satellite altitudes and distance-to-horizon (“DTH”) are also noted in FIG. 14. Links from drones to terrestrial ground nodes in wide area routes are omitted from FIG. 14 for clarity of illustration.
1. Local area routes in New York City (dash-dot-dash lines)
   Two-hop route—TN29↔AN26↔TN49 (“bent pipe”)
   Three-hop route—TN8↔AN16↔AN24↔TN29
2. Wide area routes using only layer B satellites (dash-one-circle-dash lines)
   Between Hawaii and San Francisco—AH42↔SB82↔AS12
   Between San Francisco and New York City—AS43↔SB65↔SB71↔AN12
3. Wide area route using layers B and C satellites (dash-two-circle-dash line)
   Between San Francisco and London—AS43↔SB65↔SC32↔SC12↔SB92↔AL6
4. Wide area route using layers B, C and D satellites (dash-three-circle-dash line)
   Between Hawaii and London—AH42↔SB101↔SC26↔SD2↔SC12↔SB92↔AL38

The routes shown the figure are examples only. Routes can also be created directly between satellites in non-contiguous layers (for example, between a B layer and D layer satellites), or directly between a drone and a satellite in any of layers B, C and D.

### IV. Operational Applications of Disclosed Non-Orbiting Aerial Nodes

The embodiments and principles described above support a wide variety of applications of the non-orbiting aerial nodes that are the subject of this disclosure. The structure of the non-orbiting aerial nodes and their operation can be tailored to achieve the goals of particular system. In some systems, the non-orbiting aerial nodes can be balloons or combinations of balloons and one or more of the drones depicted in FIGS. 1 to 11 or variations thereof. In one embodiment the balloon node would comprise the balloon itself and an operating capsule identical in function to the drone 10, but without a gas bladder GB, suspended by a wire from the balloon. That balloon embodiment would be maneuverable using the MSA control module 216. The operating capsule could also be an oblate spheroid like the communications capsule 1030 with like arrays of antennas, and solar panels and batteries. The balloon node could be deployed at altitudes from 1 to 10 miles. In other embodiments balloon nodes can be tethered to the ground at lower heights, say 400 ft., for stronger links with users on the ground.

The actual physical size of the antennas would depend on how much power is needed, and the amount of solar power generation that would be required. In addition, the number of downward-, sideways-, and upward-facing antennas on the drones can be varied depending upon different traffic needs. The separate control of the respective antenna arrays by the top antenna route creation/data transmission circuitry 312, side antenna route creation/data transmission circuitry 314, and bottom antenna route creation/data transmission circuitry 316 would allow a particular system to use different frequencies for creating upward, sideways and downward links. This would also permit each of the respective arrays 102, 104 and 106 to have different size antennas. In systems in which the terrestrial nodes have more power, the bottom antenna array could have less stringent operational requirements. Conversely, in certain locations such as a military theater the antennas in the bottom array may have to connect with weaker signals from combat troops and thus require a bottom array with antennas designed to that purpose and/or with more antennas. In a system designed to monitor worldwide oil platforms, the downward pointing antennas would preferably be capable of picking up signals from multiple oil platforms over a broad area. In a system designed to provide coverage to users on a remote island, or to a small city in the middle of a desert, where all of the users are located in a relatively small area, the antennas can be designed and arranged on the drones accordingly.

The use of different frequencies for different antenna arrays also enables the drones (or balloons) to be adapted for myriad particular applications. For example, using different frequencies for sideways-pointing antennas and downward-pointing antennas enables more efficient use of bandwidth. In one application, the sideways-pointing antennas could use a first frequency band dedicated to creating drone-to-drone radio links, and the downward-pointing antennas could use a different second frequency band already allocated to local police or firefighters. That could be particularly advantageous during a forest fire in a remote area where reliable communications between firefighting personnel is critical. A variation of that arrangement could enhance communications in a combat theater where infantry soldiers and tanks need to exchange information in real time. A first frequency band would be dedicated to drone-to-drone radio links, and with a select number of downward-pointing antennas using a portion of a different second frequency band for radio links with tanks and the remaining downward-pointing antennas using a different portion of the second frequency band for radio links with infantry soldiers. The placement of the antennas in the downward-pointing array 106 enables those using the first frequency and second frequencies to spread out along the bottom of the drone. For example, the first frequency band portion could use the bottom array antennas 106a and 106c and the antennas 106a and 106c (and their sideways-right-offset counterparts) with the second frequency band portion using the remaining bottom array antennas. In a system that includes satellites the upward pointing antennas could use a third frequency band different from the first and second frequency bands.

The disclosed drones (and balloons) can also be used in cellular telephone communications in remote areas without an available base station. Routes created as discussed above can be used to transmit cellular telephone calls in a way that is directly analogous to the manner in which data is transmitted via the multi-level system depicted in FIG. 14. The destination telephone number in a particular call can perform the same function as the destination address in a data transmission vis-à-vis the zip code paradigm described earlier. A cellular telephone provider could implement such a system without disrupting normal telephone service by allocating a small percentage (say 10%) of its government-allotted frequency band to routing methods in this disclosure for providing service in areas where a user's device cannot connect to a base station.

Other drone/balloon embodiments can include more or fewer sets of antennas, controlled independently or otherwise. In some systems the downward-pointing antennas and the sideways-pointing antennas can be controlled by the same route creation/data transmission circuitry in situations in which the anticipated local traffic will be low. This will reduce drone cost while still enabling it to adequately handle the local traffic. In another variation, an application in which the antennas in single array use different frequencies the respective route creation/data transmission circuitry dedicated to that antenna array can use a different microprocessor to control the antennas in the different arrays.

### V. Summary and Conclusion

The drones described herein provide a powerful way of implementing the multi-tier drone/satellite system described in FIG. 14 that is capable of enabling both local area and long distance worldwide radio communications in one integrated system. Many previous proposals for drones capable of radio communication used large, solar powered, heavier-than-air aircraft. Known such drones have been very expensive and would require extensive modification to function as drones in a multi-level system like that described here and in the '796 publication. In fact, many, if not most, of the hardware and software features of the drones described here, and the manner of controlling them and creating radio routes among themselves and with orbiting satellites, would have been beyond the ken of anyone of ordinary skill in the art. The drones described here are relatively inexpensive, which makes them both cheaper to manufacture in sufficient numbers to support communications systems like those described here and also cheaper to replace if they are damaged or fail in operation. Even without replacements, the routing algorithms described above will automatically recreate routes through the system without the missing drones during the next route creation cycle.

Those skilled in the art will readily recognize that many other variations on the embodiments selected to exemplify the many structures and methods comprising the disclosed subject matter are possible. This entire disclosure is presented to describe the basic principles and operational characteristics of the systems, methods and apparatus forming its subject matter and enable one skilled in the art to implement them. It is in no way limiting as to other embodiments and implementations within its spirit and scope.

1. A lighter-than-air (LTA) non-orbiting aerial node for deployment in a radio communication system including at least one terrestrial node and a plurality of said LTA non-orbiting aerial nodes capable of providing a radio route including at least one said LTA non-orbiting aerial node, said LTA non-orbiting aerial node comprising a rigid casing including:
an antenna construction for transmitting and receiving radio signals in a plurality of directions;
route creation circuitry for determining a quality associated with a routing message received from at least one of a terrestrial node or another non-orbiting aerial node indicating the suitability of including as a link in the radio route (i) said LTA non-orbiting aerial node and said terrestrial node or (ii) said LTA non-orbiting aerial node and said other non-orbiting aerial node, said route creation circuitry including a memory for storing an identity of an antenna associated with a received routing message;
data transmission circuitry for transmitting data from said LTA non-orbiting aerial node to said terrestrial node or to said other non-orbiting aerial node using said antenna the identity of which is stored in said memory;
batteries for powering said route creation circuitry and said data transmission circuitry; and
a lighter-than-air gas for providing a lifting force on said LTA non-orbiting aerial node.

2. An LTA non-orbiting aerial node as in claim 1, wherein said antenna construction includes a plurality of directional antennas for pointing horizontally generally parallel to the surface of the earth in multiple directions in the space around said casing to send radio signals to and receive radio signals from other non-orbiting aerial nodes when said LTA non-orbiting aerial node is deployed in said radio communication system.

3. An LTA non-orbiting aerial node as in claim 2, wherein said antenna construction includes a plurality of directional antennas for pointing generally toward the surface of the earth to send radio signals to and receive radio signals from multiple terrestrial nodes when said LTA non-orbiting aerial node is deployed in said radio communication system.

4. An LTA non-orbiting aerial node as in claim 3 for use in a radio communication system further including a plurality of orbiting satellites, wherein said antenna construction includes a plurality of directional antennas for pointing generally upwardly away from the surface of the earth to send radio signals to and receive radio signals from said satellites when said LTA non-orbiting aerial node is deployed in said radio communication system.

5. An LTA non-orbiting aerial node as in claim 4, wherein said directional antennas comprise parabolic antennas.

6. An LTA non-orbiting aerial node as in claim 1, wherein:
said casing is in the shape of a prolate spheroid with an x-axis along the major axis thereof and a z-axis defining with said x-axis an x-z plane oriented parallel to the surface of the earth when said LTA non-orbiting aerial node is deployed in said radio communication system; and
said casing includes a bladder for containing said lighter-than-air gas.

7. An LTA non-orbiting aerial node as in claim 1, wherein said quality comprises the signal strength of said received routing message measured by said route creation circuitry.

8. An LTA non-orbiting aerial node as in claim 1, wherein said batteries are rechargeable and casing further includes a guidance and propulsion system powered by said rechargeable batteries for controlling the location and orientation of said LTA non-orbiting aerial node and solar panels for recharging said batteries.

9. A lighter-than-air (LTA) non-orbiting aerial node for use in a radio communication system including at least one terrestrial node and a plurality of said LTA non-orbiting aerial nodes capable of providing a radio route including at least one said LTA non-orbiting aerial node, said LTA non-orbiting aerial node comprising a rigid casing and a communication capsule suspended from said rigid casing, wherein:
said communication capsule includes:
(a) an antenna construction for transmitting and receiving radio signals in a plurality of directions,
(b) route creation circuitry for determining a quality associated with a routing message received from at least one of a terrestrial node or another non-orbiting aerial node indicating the suitability of including as a link in the radio route (i) said LTA non-orbiting aerial node and said terrestrial node or (ii) said LTA non-orbiting aerial node and said other non-orbiting aerial node, said route creation circuitry including a memory for storing an identity of an antenna associated with a received routing message, and
(c) data transmission circuitry for transmitting data from said LTA non-orbiting aerial node to said terrestrial node or to said other non-orbiting aerial node using said antenna the identity of which is stored in said memory; and
said casing includes:
(a) a guidance and propulsion system for controlling the location and orientation of said LTA non-orbiting aerial node, batteries for powering said guidance and propulsion system, said route creation circuitry and said data transmission circuitry,
(b) a lighter-than-air gas for providing a lifting force on said LTA non-orbiting aerial node.

10. An LTA non-orbiting aerial node as in claim 9, wherein said antenna construction includes:
a plurality of directional antennas for pointing horizontally generally parallel to the surface of the earth in multiple directions in the space around said casing to send radio signals to and receive radio signals from other non-orbiting aerial nodes when said LTA non-orbiting aerial node is deployed in said radio communication system; and
a plurality of directional antennas for pointing generally toward the surface of the earth to send radio signals to and receive radio signals from multiple terrestrial nodes when said LTA non-orbiting aerial node is deployed in said radio communication system.

11. An LTA non-orbiting aerial node as in claim 10 for use in a radio communication system further including a plurality of orbiting satellites, wherein said antenna construction includes a plurality of directional antennas for pointing generally upwardly away from the surface of the earth to send radio signals to and receive radio signals from said satellites when said LTA non-orbiting aerial node is deployed in said radio communication system.

12. An LTA non-orbiting aerial node as in claim 11, wherein said directional antennas comprise parabolic antennas.

13. An LTA non-orbiting aerial node as in claim 9, wherein:
said batteries are rechargeable and said casing includes solar panels for recharging said batteries and a bladder for containing said lighter-than-air gas;
said casing is in the shape of a prolate spheroid with an x-axis along the major axis thereof and a z-axis defining with said x-axis an x-z plane oriented parallel to the surface of the earth when said LTA non-orbiting aerial node is deployed in said radio communication system; and
said communication capsule is in the shape of an oblate spheroid mounted to said casing for rotation about an axis normal to said x-z plane.

14. An LTA non-orbiting aerial node as in claim 9, wherein said quality comprises the signal strength of said received routing message measured by said route creation circuitry.

15. A lighter-than-air (LTA) non-orbiting aerial node for use in a radio communication system including at least one terrestrial node and a plurality of said LTA non-orbiting aerial nodes capable of providing a radio route including at least one said LTA non-orbiting aerial node, said LTA non-orbiting aerial node comprising a balloon for holding said LTA non-orbiting aerial node against the force of gravity and a communication capsule suspended from said balloon, wherein said communication capsule includes:
an antenna construction for transmitting and receiving radio signals in a plurality of directions;
route creation circuitry for determining a quality associated with a routing message received from at least one of a terrestrial node or another non-orbiting aerial node indicating the suitability of including as a link in the radio route (i) said LTA non-orbiting aerial node and said terrestrial node or (ii) said LTA non-orbiting aerial node and said other non-orbiting aerial node, said route creation circuitry including a memory for storing an identity of an antenna associated with a received routing message;
data transmission circuitry for transmitting data from said LTA non-orbiting aerial node to said terrestrial node or to said other non-orbiting aerial node using said antenna the identity of which is stored in said memory; and
batteries for powering said route creation circuitry and said data transmission circuitry.

16. An LTA non-orbiting aerial node as in claim 15, wherein said antenna construction includes:
a plurality of directional antennas for pointing horizontally generally parallel to the surface of the earth in multiple directions in the space around said casing to send radio signals to and receive radio signals from other non-orbiting aerial nodes when said LTA non-orbiting aerial node is deployed in said radio communication system; and
a plurality of directional antennas for pointing generally toward the surface of the earth to send radio signals to and receive radio signals from multiple terrestrial nodes when said LTA non-orbiting aerial node is deployed in said radio communication system.

17. An LTA non-orbiting aerial node as in claim 16 for use in a radio communication system further including a plurality of orbiting satellites, wherein said antenna construction includes a plurality of directional antennas for pointing generally upwardly away from the surface of the earth to send radio signals to and receive radio signals from said satellites when said LTA non-orbiting aerial node is deployed in said radio communication system.

18. An LTA non-orbiting aerial node as in claim 17, wherein said directional antennas comprise parabolic antennas.

19. An LTA non-orbiting aerial node as in claim 16, wherein:
said communication capsule is in the shape of an oblate spheroid having a substantially circular cross-section oriented parallel to the surface of the earth when said LTA non-orbiting aerial node is deployed in said radio communication system; and
said batteries are rechargeable and said casing includes solar panels for recharging said batteries.

20. An LTA non-orbiting aerial node as in claim 16, wherein said communication capsule further includes a guidance and propulsion system powered by said batteries for controlling the location and orientation of said LTA non-orbiting aerial node.

21. A heavier-than-air (HTA) non-orbiting aerial node for use in a radio communication system including at least one terrestrial node and a plurality of said HTA non-orbiting aerial nodes capable of providing a radio route including at least one said HTA non-orbiting aerial node, said HTA non-orbiting aerial node comprising a rotary-wing aircraft and a communication capsule suspended from said rotary-wing aircraft, wherein:
said communication capsule includes:
(a) an antenna construction for transmitting and receiving radio signals in a plurality of directions,
(b) route creation circuitry for determining a quality associated with a routing message received from at least one of a terrestrial node or another non-orbiting aerial node indicating the suitability of including as a link in the radio route (i) said HTA non-orbiting aerial node and said terrestrial node or (ii) said HTA non-orbiting aerial node and said other non-orbiting aerial node, said route creation circuitry including a memory for storing an identity of an antenna associated with a received routing message, and
(c) data transmission circuitry for transmitting data from said LTA non-orbiting aerial node to said terrestrial node or to said other non-orbiting aerial node using said antenna the identity of which is stored in said memory; and
said rotary-wing aircraft includes:
(a) a guidance and propulsion system for controlling the location and orientation of said HTA non-orbiting aerial node, batteries for powering said guidance and propulsion system, said route creation circuitry and said data transmission circuitry,
(b) a lighter-than-air gas to provide a lifting force on said HTA non-orbiting aerial node.

22. An HTA non-orbiting aerial node as in claim 21, wherein said antenna construction includes:
a plurality of directional antennas for pointing horizontally generally parallel to the surface of the earth in multiple directions in the space around said casing to send radio signals to and receive radio signals from other non-orbiting aerial nodes when said HTA non-orbiting aerial node is deployed in said radio communication system; and
a plurality of directional antennas for pointing generally toward the surface of the earth to send radio signals to and receive radio signals from multiple terrestrial nodes when said HTA non-orbiting aerial node is deployed in said radio communication system.

23. An HTA non-orbiting aerial node as in claim 22 for use in a radio communication system further including a plurality of orbiting satellites, wherein said antenna construction includes a plurality of directional antennas for pointing generally upwardly away from the surface of the earth to send radio signals to and receive radio signals from said satellites when said HTA non-orbiting aerial node is deployed in said radio communication system.

24. An HTA non-orbiting aerial node as in claim 23, wherein said directional antennas comprise parabolic antennas.

25. An HTA non-orbiting aerial node as in claim 21, wherein:
said communication capsule is in the shape of an oblate spheroid and is mounted to said rotary-wing aircraft for rotation;
said batteries are rechargeable and said rotary-wing aircraft includes solar panels for recharging said batteries; and
said rotary-wing aircraft is constructed for operation with an axis of rotation of said oblate spheroid substantially normal to the surface of the earth when said HTA non-orbiting aerial node is deployed in said radio communication system.

26. A non-orbiting aerial node for use in a radio communication system including at least one terrestrial node and a plurality of said non-orbiting aerial nodes capable of providing a radio route including at least one said non-orbiting aerial node, said non-orbiting aerial node comprising:
an antenna construction for transmitting and receiving radio signals in a plurality of directions, wherein said antenna construction includes a plurality of directional antennas pointing horizontally generally parallel to the surface of the earth in multiple directions in the space around said non-orbiting aerial node for sending radio signals to and receiving radio signals from other non-orbiting aerial nodes in a first frequency band and a plurality of directional antennas pointing generally toward the surface of the earth for sending radio signals to and receiving radio signals from multiple terrestrial nodes in a second frequency band different from said first frequency band;
route creation circuitry for determining a quality associated with a routing message received from at least one of a terrestrial node or another non-orbiting aerial node indicating the suitability of including as a link in the radio route (i) said non-orbiting aerial node and said other non-orbiting aerial node, or (ii) said non-orbiting aerial node and said terrestrial node, said route creation circuitry including a memory for storing an identity of an antenna associated with a received routing message; and
data transmission circuitry for transmitting data from said non-orbiting aerial node to said terrestrial node or to said other non-orbiting aerial node using said antenna the identity of which is stored in said memory.

27. A non-orbiting aerial node as in claim 26, wherein a first number of said directional antennas pointing generally toward the surface of the earth send and receive radio signals in a first portion of said second frequency band and a second number of different directional antennas send and receive radio signals in a second portion of said second frequency band different from said first portion.

28. A non-orbiting aerial node as in claim 27 for use in a radio communication system further including a plurality of orbiting satellites, wherein said antenna construction includes a plurality of directional antennas pointing generally upwardly away from the surface of the earth for sending radio signals to and receiving radio signals from said satellites in a third frequency band different from said first and second frequency bands.

29. A non-orbiting aerial node as in claim 28, wherein said directional antennas comprise parabolic antennas.

30. A non-orbiting aerial node as in claim 27, wherein said quality comprises the signal strength of said received routing message measured by said route creation circuitry.

31. A non-orbiting aerial node as in claim 26 comprising a lighter-than-air (LTA) aerial node with a rigid casing including said antenna construction, said route creation circuitry, said data transmission circuitry, rechargeable batteries for powering said route creation circuitry and said data transmission circuitry, solar panels for recharging said batteries, and a bladder for containing a lighter-than-air gas to provide a lifting force on said LTA aerial node.

32. A non-orbiting aerial node as in claim 26 comprising a lighter-than-air (LTA) aerial node with a rigid casing and a communication capsule suspended from said rigid casing, wherein:
said communication capsule said antenna construction, said route creation circuitry, and said data transmission circuitry; and
said casing includes a guidance and propulsion system for controlling the location and orientation of said LTA aerial node, rechargeable batteries for powering said guidance and propulsion system, said route creation circuitry and said data transmission circuitry, solar panels for recharging said batteries, and a bladder for containing a lighter-than-air gas to provide a lifting force on said LTA aerial node.

33. A non-orbiting aerial node as in claim 26 comprising a lighter-than-air (LTA) aerial node including a balloon for holding said LTA aerial node against the force of gravity and a communication capsule suspended from said balloon, wherein said communication capsule includes said antenna construction for transmitting and receiving radio signals in a plurality of directions, said route creation circuitry, said data transmission circuitry, rechargeable batteries for powering said route creation circuitry and said data transmission circuitry, and solar panels for recharging said batteries.

34. A non-orbiting aerial node as in claim 26 comprising a heavier-than-air (HTA) node comprising a rotary-wing aircraft and a communication capsule suspended from said rotary-wing aircraft, wherein:
said communication capsule includes said an antenna construction, said route creation circuitry, and said data transmission circuitry; and
said rotary-wing aircraft includes a guidance and propulsion system for controlling the location and orientation of said HTA non-orbiting aerial node, rechargeable batteries for powering said guidance and propulsion system, said route creation circuitry and said data transmission circuitry, solar panels for recharging said batteries, and a bladder for containing a lighter-than-air gas to provide a lifting force on said HTA node.

35.-50. (canceled)
